(19) United States
(12) Patent Application Publication
(10) Pub. No.: US 2008/0103897 A1
(43) Pub. Date: May 1, 2008

(54) NORMALIZING AND TRACKING USER ATTRIBUTES FOR TRANSACTIONS IN AN ADVERTISING EXCHANGE

(75) Inventors: Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Brian Burdick, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/735,753

(22) Filed: Apr. 16, 2007

Related U.S. Application Data
(60) Provisional application No. 60/862,969, filed on Oct. 25, 2006.

(51) Int. Cl. G06Q 30/00

(52) U.S. Cl. 705/14

(57) ABSTRACT

For a multi-party advertising exchange including advertising and publishing entities, each publishing entity can expose user attribute space(s) for its publishing inventory to the exchange, which are normalized to a common vocabulary within the exchange. Similarly, each advertising entity can specify one or more preferences for user attributes as requirements or definitions for advertising transactions in the exchange which are also normalized to the common vocabulary. The common vocabulary enables the comparison of a first set of user attributes to a second set of user attributes within the exchange. Supplemental user attribute data may also be received from audience data brokers, and the performance of advertising as a function of sets and subsets of user attributes over time may be recorded so that optimal display strategies can be determined. Publishers that meet certain requirements can pre-qualify their publishing inventory for a given set of user attributes raising certainty in advertising transactions. Various system refinements are provided and disclosed according to a host of optional embodiments.

### TECHNICAL FIELD

The subject disclosure relates to the normalization and tracking of user attributes for advertising transactions according to a common vocabulary in online advertising architectures and environments.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

For instance, elaborating on the lack of standards around terms and conditions of existing advertising transactions, there are a variety of disparate items in an advertising exchange that should be able to be compared, except today, they cannot be compared because of disparate definitions set forth by different participants and different standards followed by different participants.

An example of this lack of standards is with respect to the way that user attribute spaces for publishing inventory are defined by participants. In this regard, today, user attribute spaces are defined differently by each publisher ad hoc, defined by some participants in much more detail than other participants across a whole range of detail and hierarchical representation of user attribute spaces.

For instance, a first Web site, such as Yahoo.com, may record, for each of its many users, a large data structure with many user attributes of varying granularity, e.g., a vector of 4000 different items about a user, ranging from broad demographic information, such as age and gender, to more particular user information, such as “how much time in the past week the user spent on sports related activity”. Such information might include, within the same category, information as a sub-category of the category, or sub-sub-category, and so on. For instance, such user information might include “time spent on entertainment related activity” and also include a more particular sub-category of “time spent on Britney Spears related properties” tracked separately from the entertainment category.

In contrast, a second Web site, such as MSN.com, may only record a few hundred attributes, such as 200 attributes, for each of its users. For instance, while age and gender might be included as user information, other categories such as “time spent on Britney Spears related properties” may not be tracked at all. Moreover, the data underlying a category may not mean exactly the same thing. For instance, while MSN.com may also include a category “number of times clicked to entertainment related activity,” which since represented as a number rather than a duration, may not map precisely to the exact same “entertainment” metric.

Thus, the problem today is not being able to compare disparate user attribute spaces owing to inconsistency of definitions across different publishing spaces for transactions in an exchange. In short, a set of 4000 user attributes is difficult to map to a set of 200 user attributes. Thus, these user attributes are currently defined by publishers in a variety of ways, and formats, creating a lot of uncertainty over the way advertising will perform across different publishing inventory with differently defined user attribute spaces.

Thus, what is desired for an online advertising exchange is a way to specify or define advertising user attributes across different publishers in a common way, so that different user attribute spaces defined by different participants can be compared for advertising transactions in an advertising exchange. It would be further desirable to be able to define user attribute spaces of different participants according to a common user attribute space, and then to automatically track the performance of the advertising as a function of the user attributes that apply to the performance of advertising across all of the participants in the exchange. This would beneficially allow different participants to compare the performance of the same advertising with respect to different user attributes of different publishers, or the performance of different advertising under conditions of similar user attributes. Such comparisons would allow participants to advertising transactions to make better, more rational decisions about the expected return on investment for advertising dollars based on a common understanding of user attribute spaces across different publishers.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities, each publishing entity can expose user attribute space(s) for its publishing inventory to the exchange, which are normalized to a common vocabulary within the exchange. Similarly, each advertising entity can specify one or more preferences for user attributes as requirements or definitions for advertising transactions in the exchange which are also normalized to the common vocabulary. The common vocabulary of the invention enables the comparison of a first set of user attributes to a differently, defined second set of user attributes within the exchange.

The invention also optionally receives supplemental user attribute data from audience data brokers, and records the performance of advertising as a function of sets and subsets of user attributes over time so that optimal display strategies can be determined by participants with access to the performance information. Publishers that meet certain requirements can pre-qualify their publishing inventory for a given set of user attributes raising certainty in advertising transactions.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the normalizing and tracking of user attributes for online advertising in accordance with the present invention are further described with reference to the accompanying drawings in which:

FIG. 1 is a block diagram of a computing system environment suitable for use in implementing the present invention;

FIG. 2 illustrates a distributed architecture for online advertising according to embodiments of the present invention;

FIG. 3 illustrates one example of the flow of data within architecture 200 according to embodiments of the present invention;

FIG. 4 illustrates a flowchart of the operation of an exchange according to embodiments of the present invention;

FIG. 5 illustrates a flowchart of the operation of an audience data broker according to embodiments of the present invention;

FIG. 6 is an exemplary non-limiting block diagram of embodiments of an online advertising exchange in accordance with the invention;

FIG. 7 is another exemplary non-limiting block diagram of embodiments of an online advertising exchange in accordance with the invention;

FIG. 8 is an exemplary block diagram illustrating an alternate embodiment of an online advertising exchange in accordance with the invention;

FIGS. 9A and 9B are exemplary block diagrams illustrating further alternate embodiments of an online advertising exchange in accordance with the invention;

FIGS. 10A and 10B illustrate exemplary normalization of disparate formats for expressing user attributes for transactions in an online advertising exchange in accordance with the invention;

FIGS. 11A and 11B are exemplary, non-limiting block diagram illustrations of normalizing transactions in an online advertising exchange based on user attributes specified by the participants in the context of keywords in accordance with the invention;

FIG. 12 illustrates exemplary processes for conversion tracking in a distributed online advertising exchange in accordance with the invention;

FIGS. 13A and 13B illustrate exemplary processes for conversion tracking in a distributed online advertising exchange in accordance with the invention;

FIG. 14 illustrates another exemplary block diagram illustrating the normalizing of disparate publisher user attribute spaces in an online advertising exchange in accordance with the invention;

FIG. 15 illustrates another exemplary block diagram illustrating the normalizing of disparate advertiser preferences for user attribute spaces in an online advertising exchange in accordance with the invention;

FIG. 16 illustrate exemplary tools and proceses for participants to express or receive one or more user attributes for normalization by an online advertising exchange in accordance with the invention;

FIG. 17 illustrates an exemplary range or continuum along a spectrum for defining one or more preferences for user attributes in accordance with the invention;

FIG. 18 is a block diagram illustrating the filtering or weighting of user attributes that may be specified by a participant to an online advertising exchange in accordance with the invention;

FIG. 19 is a flow diagram illustrating an exemplary process for receiving and normalizing user attributes input by participants to an exchange in accordance with the invention; and

FIG. 20 is a flow diagram illustrating an exemplary process for tracking user attributes as a function of user attributes for transactions of an exchange in accordance with the invention.

### DETAILED DESCRIPTION

### Overview

In various non-limiting embodiments, the invention is described in the context of a distributed architecture for online advertising, i.e., a market mechanism that manages the exchange of advertising goods among multiple participants on the advertising and/or publishing side. For instance, for a multi-party advertising exchange, the invention enables each publisher or publisher broker to maintain and track its own set of user attributes for viewers of its publishing inventory, which are automatically mapped to a pre-selected set of user attributes, which are used within the exchange as a basis for tracking the performance of advertising as a function of sets and subsets of user attributes across all of the participants to the advertising exchange. The number of elements may or may not be of lower dimensionality than the set of user attributes selected by publishers.

This allows disparate definitions of user attributes by multiple publishers, or publisher brokers, to be normalized within the advertising exchange enabling the comparison or translation of a first set of user attributes to a second set of user attributes in quantifiable terms. Optionally, the invention enables a reverse translation from a common representation of user attributes used within the exchange to the set of user attributes defined by a publisher, to enable a view over user attribute data by the publisher that is in the language of their own user attribute space.

As mentioned, the reverse mapping may not preserve all of the original information since either the forward mapping or reverse mapping may result in the loss of detail about users. To gain a reverse mapping, a publisher can provide the reverse mapping, or predictive algorithms may be used to automatically generate a reverse mapping. The predictive algorithms may include a portion that is a function of the forward mapping function, e.g., where a 1-to-I relationship exists in the forward mapping. For instance, user attributes defined in Kilograms by a publisher might be defined in pounds in the exchange, and accordingly a reverse mapping from pounds to Kilograms may also be constructed. In addition, a probabilistic mapping function can also be implemented that determines, with some predictive or probabilistic measure, the extent to which different user attribute elements of the publisher spaces and normalized space of the exchange mathematically correlate. For instance, where a publisher lacks information about users' “ages,” the publisher's knowledge of user “income” instead can be used to probabilistically map to a normalized exchange user attribute element “age” based on known demographic relationships between income and age.

Moreover, the invention enables the automatic tracking of sets and subsets of user attributes associated with publishing of advertising across all participants in the exchange. As a result, better performance data is available from which to evaluate and make advertising decisions based on the way that advertising actually performs under the user conditions represented by the sets and subsets of user attributes.

Overall, increasing the amount of knowledge of parties to a transaction makes for a more efficient transaction since knowledge can reduce uncertainty and risk in decision making by the parties. In this respect, the invention increases the ability of participants to an advertising exchange to make more rational decisions about advertising transactions vis-a-vis a common view of user attributes for publisher's inventory, and via the ability to track this user attribute information over time enabling comparison of the performance of different sets and subsets of user attributes across all publishers in the exchange. As a result, the advertising marketplace is better defined as between individual participants, making for more efficient and rational transactions among those participants, and yielding a more efficient marketplace for all.

In various non-limiting embodiments, an advertising system to facilitate trading of advertising includes (A) a publisher broker to represent publishers that determines an ask for an advertisement space on the publishers' inventory, such as a webpage, (B) an advertiser broker to represent advertisers that manages the advertisers' bids for the advertisement space and (C) an exchange to facilitate a transaction for the advertisement space between the publisher broker and the advertiser broker.

When participating in the exchange, a publishing entity records a user attribute profile for the users of the publishing inventory owned by the publishing entity. Then, the user attribute profile of the publishing entity is translated to a common user attribute space used in the exchange by mapping each element of the user attribute profile to zero, one or more elements of the common user attribute space according to a mapping function.

In one non-limiting embodiment of the invention, the mapping function from a publisher's user attribute space to the common user attribute space of the exchange is invertible so that a set of user attributes defined in the common user attribute space can be redefined in the format of the publisher's user attribute space. While an inversion that preserves the resolution of the information is likely not going to exist, since, for example, a sports site will likely have much richer sports-related user attributes than the normalized set of the exchange, and the inverse may be determined according to predictive algorithms that predictively map from the normalized set of the exchange to the participant's attribute space. Optionally, the participant can explicitly provide an inverse mapping function to the participant's attribute space so that participant becomes the predictor for how the normalized attribute space best corresponds to the participant's attribute space.

While any method for subdividing the potential number of user attributes that could be recorded by the exchange may be implemented for the common vocabulary utilized in the exchange, in one exemplary, non-limiting embodiment of the invention, the common user attribute space of the exchange has a lower dimensionality (fewer separate user attributes) than the publisher's user attribute space. In such a case, the mapping function for some elements may be no mapping, while other elements may map directly to another element on a one-for-one base, while other elements may partially map to another element, while still other elements may map partially or in whole to multiple other elements.

Thus far, the exemplary non-limiting embodiments of the invention described herein have described that each user attribute element of a publisher user attribute space has a deterministic mapping to zero, one or more elements of the normalized user attribute space of the exchange. Yet, the mapping need not be deterministic in other exemplary embodiments of the invention, i.e., for any given user attribute element of a user attribute space, there may be no deterministic function from the element to a normalized element or set of element(s). Instead what may be provided is a probabilistic mapping function that determines, with some predictive or probabilistic measure, the extent to which the element mathematically correlates with the normalized element(s) of the exchange. For instance, supposing there is a single normalized element “age” within the exchange that gives the age of a user in years since birth, but a publisher only knows about “income” for his users. In such a case, a probabilistic mapping can be generated from known statistics to correlate income for the publisher's users to the age element within the exchange. While the mapping will not be perfect, since there is a non-zero somewhat strong correlation between income and age, such a probabilistic mapping will tend to produce better user information for participants in the exchange on average than if it were absent. Thus, the mappings to normalized user attribute space need not be deterministic, and may be probabilistic for zero or more elements of the normalized user attribute space.

In other aspects, the invention enables direct comparisons of disparate user attribute spaces of different participants by normalizing the disparate user attributes to a standard user attributes representation within the advertising exchange. Comparisons can also be made for how different sets and subsets of user attributes perform over time. In one non-limiting embodiment, participants specify different user attributes according to a predetermined set of categories of user attributes that are relatively established in the actuarial and advertising industries.

Any common user attribute space may be selected that has a mapping function from the attribute spaces of publishers participating in the exchange. The mapping function may also optionally be to and from the attribute spaces (i.e., an invertible mapping function). For a non-limiting example, the user attributes of the common space may include “gender,” “age,” “location” and “income,” which are good candidates for the common user attribute space within the exchange because all publishers generally keep track of these kinds of demographic categories. Accordingly, as long as there is a mapping function between publisher user attribute spaces and the common user attribute space, the common user attribute space can be any predetermined set of categories, e.g., different categories and subcategories well known for demographics purposes, and may be represented at any level(s) of granularity.

As mentioned, different parties' user attribute spaces may be tracked differently according to different vocabularies by different parties, but the exchange operates to normalize the definitions of user attributes of the different parties into a common format within the exchange so that disparate user attribute spaces of different participants can be compared directly. For instance, any party can specify a set of user attributes of importance to the party, and based on known mappings between different user attribute spaces to the common space of the invention, user attributes across different parties can be normalized in the exchange. Accordingly, when transacting with a publishing entity within the exchange, advertising entities are shown information relating to the user attribute spaces of the publishing entities representing the inventory sought by the advertising entities. As a result, advertising entities are able have a standard view of the user attributes they seek as part of advertising transactions, and compare them across different publishing entities.

In this regard, each party can specify respective maximization functions based on different user attributes of importance to that party. Since each party has unique business goals and objectives, a wide variety of objectives may be toggled, or modified in accordance with the invention to specify desirable user attributes represented within the exchange. In response, the exchange acts to facilitate transactions with publishers that have the desirable user attributes specified by an advertising entity. In one embodiment of the invention, publishing entities can pre-qualify publishing inventory for a set of given user attributes, enabling a product within the exchange for which advertising entities will pay a premium.

In another embodiment, performance tracking, such as conversion tracking, relative to user attributes is enabled for the exchange of the invention to provide a more solid understanding of conversion rate for advertising based on the set of user attributes associated with the users that were present at the time of publishing. In essence, it is known that by increasing one's performance for advertising, a marketer can lower the cost per acquisition without changing the cost paid for traffic. Even a small increase in performance can have a dramatic profit impact, and so it is desirable to find publishing space with a high expected performance.

With performance tracking provided in the distributed framework for online advertising in accordance with the invention, pricing can be made more accurate because conversion information is available across parties. In this respect, a lousy audience for a product (e.g., low probability of purchase) is priced lower due to lesser demand for lousy customers, which will encourage publishers to maintain the quality of their users. Under free market principles, conversion tracking information about how certain advertisements perform when viewers satisfy certain subsets of user characteristics will help advertisers more accurately “get what they pay for,” increasing certainty of participation in the advertising exchange.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follow.

### Exemplary Operating Environment(s)

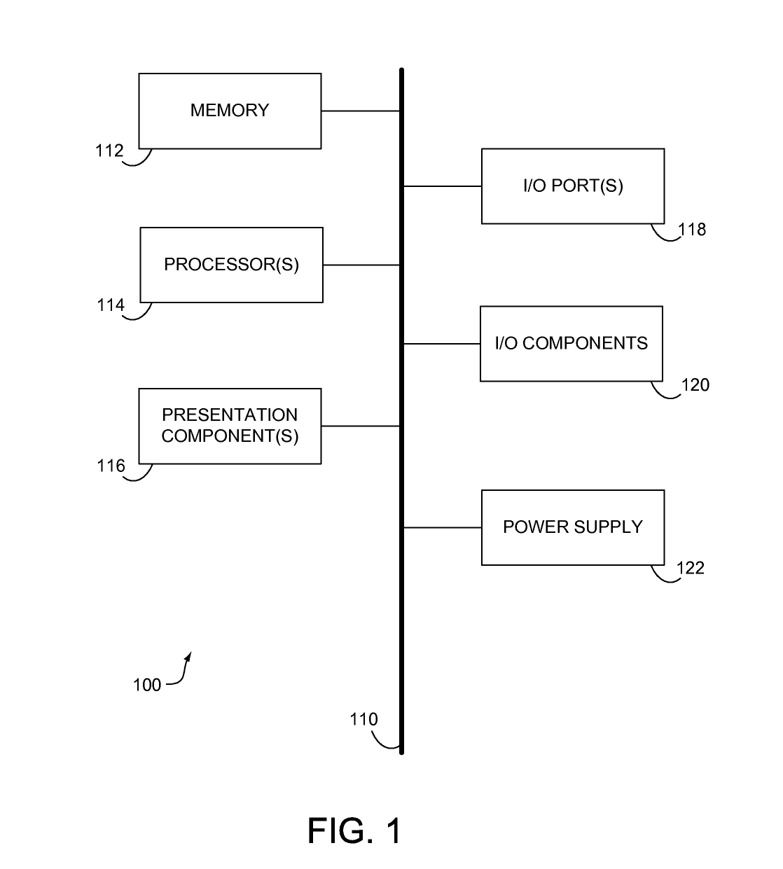

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated. In accordance with the invention, participants can communicate with an advertising exchange via one or more computing devices 100, and the advertising exchange may also comprise one or more computing devices 100, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary Architecture(s) for Online Advertising

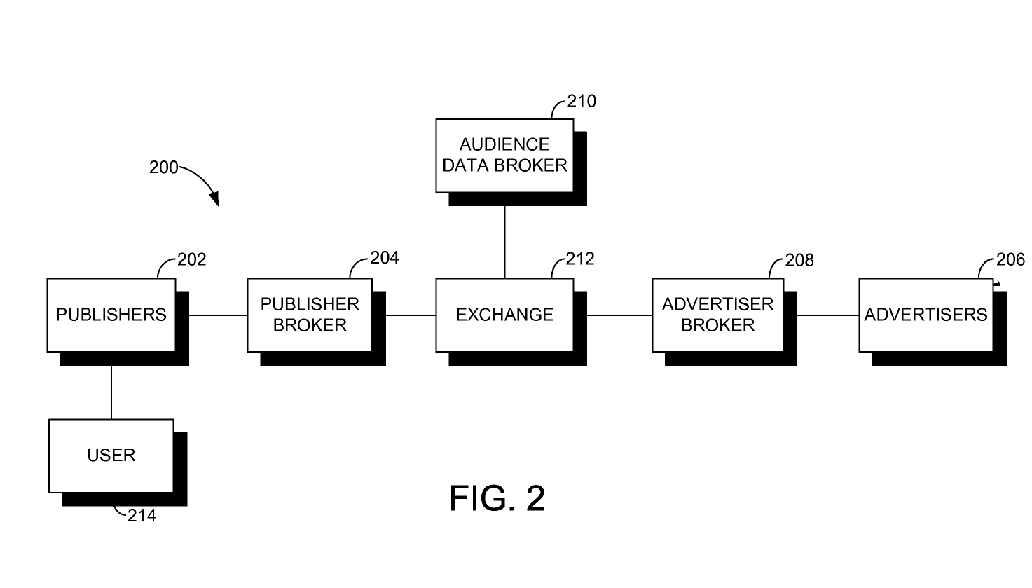

Exemplary online advertising environments or architectures in which one or more of the various embodiments of the normalization and tracking of performance of sets and subsets of different user attribute spaces of the present invention may be deployed or implemented are now described. For instance, FIG. 2 illustrates an exemplary distributed architecture 200 for online advertising, which comprises publishers 202. For purposes of explanation only, publishers 202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 202 are intended to represent any number of types, sizes, sophistication levels, etc. of publishers. In an embodiment, publishers 202 desire to sell advertisement space on their websites to advertisers 206 (discussed below).

Architecture 200 also comprises publisher broker 204. For purposes of explanation only, only one publisher broker will be discussed herein. However, embodiments of the present invention are not limited to a single publisher broker, as any number of publisher brokers may exist. In an embodiment, publisher broker 204 is an aggregator of publishers. Specifically, publisher broker 204 is an entity that represents publishers 202 with any one or more of the goals of maximizing ad revenue, ensuring quality ads, etc. Publisher broker 204 breaks the conflict of interest that is inherent in systems such as Google's AdSense by solely focusing on managing publishers 202's yield. Publisher broker 204 allows small and mid-size publishers (such as those that may be represented by publishers 202) to aggregate in order to drive higher yield for themselves. In an embodiment, publisher broker 204 maintains a user interface through which it interacts with publishers 202 and through which it manages publishers 202's preferences.

In an embodiment, publisher broker 204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed, what the publisher broker can expect in terms of a payment, and which incremental attributes about the user were filled, for instance, by an audience broker (see below).

Architecture 200 also comprises advertisers 206. For purposes of explanation only, advertisers 206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 200.

Publishers may be interested in the audience information, independently of the advertisers on the advertising exchange. For example, a publisher may want to show different content on their web site to users based on the gender of the users, e.g., to attract more people to the site. In this regard, the publisher may be interested in buying audience information for presentation purposes, independently of the advertisers in the exchange. Thus, both advertisers and publishers participating in an advertising exchange are interested in audience information and the wider sweeping knowledge base gained by the normalized user attribute space in accordance with the invention.

In an embodiment, each advertiser purchases ad space on websites, though any digital representation of advertising can be included in embodiments of the invention. For instance, in addition to any digital representation of advertising, an advertising exchange may reflect the user attributes of billboards, printed media and publications, TV, Radio, etc., or any traditional means for publishing advertising, as long as the advertising is purchased and sold within the exchange. In this respect, any of the foregoing media can be characterized by user attributes of the viewers of publishing inventory. Accordingly, for any media represented in the exchange, the invention may act to normalize the associated user attribute space to the common user attribute space of the exchange, and to track the performance of those user attributes.

For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 206 are intended to represent any number of types, sizes, sophistication levels, etc. of advertisers. In an embodiment, advertisers 206 desire to pay money to place ads on publishers 202's websites.

Architecture 200 also comprises advertiser broker 208. For purposes of explanation only, only one advertiser broker will be discussed herein. However, embodiments of the present invention are not limited to a single advertiser broker, as any number of advertiser brokers may exist. In an embodiment, advertiser broker 208 is an aggregator of advertisers. Specifically, advertiser broker 208 is an entity that represents advertisers 206 with the goal of optimizing advertisers 206's spending and placing monetary values on displaying advertising of a particular format, on a particular website, to a particular audience. In an embodiment, advertiser broker 208 maintains a user interface through which it interacts with advertisers 206, and through which it manages advertisers 206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. This means that the advertiser does not see any user attributes that have been populated by audience data brokers (see below) as part of the exchange transaction. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 200 may also comprise audience data broker 210. For purposes of explanation only, only one audience data broker will be discussed herein. However, embodiments of the present invention are not limited to a single audience data broker, as any number of audience data brokers may exist. In an embodiment, audience data broker 210 is an aggregator of user data providers. A user data provider is any entity that maintains any partial information that can be referred back to an individual user (such as one of users 214, discussed below) for advertising purposes. For example, user data may comprise demographic, psychographic, and behavioral information. More specifically, for example, user data may comprise age, gender, wealth index, interests, shopping habits, etc. However, embodiments of the present invention are not limited to any specific type of user data. In an embodiment, audience data broker 210 is any large user data aggregator, such as PayPal, Visa, Yahoo!, Verizon, as well as an aggregate of smaller user data providers. Any online store that collects user data can function as audience data broker 210 by providing user location level and user purchase pattern level information. This information can be aggregated with demographic profiles from small web email providers to form more comprehensive user descriptions.

In an embodiment, audience data broker 210 enriches information regarding a user viewing one of publishers 202's web pages. In an embodiment, audience data broker 210 does not disclose any personally identifiable information about the user. In an embodiment, audience data broker 210 accomplishes this by performing a private user ID lookup and passing back a set of aggregate user attributes that could be consumed by advertisers 206 and advertiser broker 208. This user attribute enrichment increases the value of the display of the ad to advertisers 206, helps produce more relevant ads to consumers, and creates a more complete picture of the user for ad serving purposes without violating the user's privacy. The aggregation across different providers serves two independent roles, in an embodiment: (1) it creates a comprehensive view of the audience landscape, and (2) it thickens the data sources to allow for anonymization and preservation of user privacy.

In this regard, any representation of user attributes as understood by an audience data broker 210 may be translated to the common set of user attributes represented within the exchange in accordance with the invention, and thus, various embodiments of the invention contemplate the enrichment of exchange transactions with information from an audience data broker 210 as normalized to the common user attribute space utilized within the exchange in accordance with the invention.

In an embodiment, audience data broker 210 receives direct payment for even small and/or partial user attributes. By participating in architecture 200, audience data broker 210: (1) is paid for its information, (2) can enrich its information (even redundant data providers are useful for scoring purposes), and (3) can verify its information (providers with poor quality of data will gain insight and will be able to actively address data quality issues). In an embodiment, audience data broker 210 receives a request from publisher broker 204 proxied by exchange 212 (explained in greater detail below). Audience data broker 210 appends known user attributes into this request for the consumption of advertiser broker 208. Audience data broker 210 does not know the page that the user is on from publisher broker 204, and audience data broker 210 will not pass any user identifiers to advertiser broker 208.

In an embodiment, audience data broker 210 comprises a user data recorder to record user information into the exchange (discussed below) and a user data delivery system to respond to requests for the user information. In an embodiment, the user data recorder informs the exchange that the audience data broker knows something about a user, through whatever means that may be. To do this, when the audience data broker has contact with a user that they know something about, the audience data broker can either set up a single pixel gif call to the exchange that the user will perform, or the audience data broker can redirect the current user request to the exchange, along with the information and a destination URL for the exchange to redirect the user to afterwards. In each case, whatever information or data key the audience data broker wishes to receive back is expected to be enough so that the audience data broker can answer user data delivery system requests for the use. In an embodiment, the information passed to the exchange is signed in a manner that proves the identity of the audience data broker to the exchange. In an embodiment, the exchange, upon verifying the identity of the audience data broker, will set a cookie to the user's browser with the name of the cookie identifying the audience data broker, and the cookie value being the information provided. In an embodiment, when the exchange receives an ad request from a user (the user having been sent to the exchange from a publisher broker), if there are any user data attributes that the publisher is willing to pay an additional amount for, then the cookies for all audience data brokers are read from the user's browser. For each audience data broker identified by a cookie, if the audience data broker is currently live, the exchange will send a request to that audience broker with the cookie value and any unknown data attributes which the publisher is willing to pay to have provided. The audience data broker then responds back, including the information for as many attributes as they know, along with the price they are asking for to allow it to be used.

In an embodiment, audience data brokers can participate in an advertiser auction and get paid directly through an advertiser bid with no audience data requests from the publisher broker. This would be considered a “publisher blind” audience data delivery. If an advertisement bid meets and exceeds a publisher requested minimum, then the bid remainder left after publisher ask can be used to acquire user data and maximize advertiser ROI (return on investment) using tighter targeting. The exchange provides a call back to the winning audience data broker(s) letting them know what attributes they won on, and what amount they will be paid for that information.

For the avoidance of doubt, exemplary embodiments herein describe an audience broker in the context of advertisers benefiting from the audience information output by the audience broker, however, as noted earlier, publishers also benefit from audience information. For instance, a publisher may wish to express its goals in the exchange as a function of a specific user, or demographic target. For example, a publisher might want all the advertisements to be “age appropriate” for the users of the publisher's site.

Given that publishers and advertisers can apply payments directly to audience data brokers for specific information, in an embodiment, there is a verification and rating process for audience data brokers. Multiple audience data brokers will be competing for the same service. In an embodiment, competition is performed based on ask, but also based on quality of data. Advertisers will have transparency into the publisher broker network, and similar transparency can be offered into the audience data broker network by offering a rating system. Audience data broker ratings can be calculated dynamically through the use of overlapping collection symbols. Overlapping data could be used to calculate ground truth predictions as well as verify the data provided by individual audience data brokers. This information in turn could be used to automatically rate audience data brokers. In an embodiment, a simple voting system can be used to verify the accuracy of any specific collection symbols for each broker, or the quality of the broker as a whole. The maintainers of the exchange would be responsible for publishing the voting consensus to the public, or to disbar the broker completely if necessary.

In an embodiment, no audience data broker will be able to provide ground truth data for all users. However, it might be possible to generate such data by creating data functions based on different providers and choosing the consensus opinion for each attribute. Publishers and advertisers could choose to use the consensus opinion or any individual audience data broker's collection symbols. In an embodiment, data units of “statistically significant” user data attributes could be created. Most audience data brokers often run into privacy issues not due to the data they have, but due to the data they don't know. Holes in a user profile could be significant or unique enough to be carrying sufficient information to reconstruct a unique user. Filling-in these holes using data from other user data providers could allow those providers to generate statistically significant aggregates that can be used for research purposes without sacrificing user privacy.

In one embodiment of the invention, audience broker 210 can aggregate information about publishing trends with respect to the efficacy of certain user attributes used across a variety of publishers. Armed with this information about aggregate trends concerning the efficacy of certain display characteristics, and coupled with the ability to normalize display characteristics to a common vocabulary understood by all of the exchange participants, advertisers can be more effective in the marketplace.

Architecture 200 also comprises exchange 212. Exchange 212 acts as a mediator among publisher broker 204, advertiser broker 208, and audience data broker 210. Exchange 212 is the framework that allows publisher broker 204 to have its ads enriched with additional user data by audience data broker 210. In an embodiment, exchange 212 routes traffic and facilitates transactions, e.g., auctions, between publisher broker 204, advertiser broker 208, and audience data broker 210. In an embodiment, exchange 212 is a server or a set of servers. Exchange 212 creates a system in which audience data broker 210 can monetize its data and in which advertiser broker 208 can reach a larger audience of more highly targetable traffic. In an embodiment, exchange 212 provides minimum standards of conformity, ensuring that some base information about the request is provided to be used by advertiser broker 208, regardless of population data from publisher broker 204 and audience data broker 210.

To provide minimum standards of conformity, in an embodiment, exchange 212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 212 sends all publisher broker requests that match a set of criteria defined by the advertiser broker, along with all relevant data about the request (e.g., the ask and collection symbols provided by the publisher, audience broker, and the exchange itself). In an embodiment, if the advertiser broker has any ads that it would like to have displayed and that meet the ask, it returns those ads, up to the number of ads requested, along with a CPI (cost per impression) bid on each. However, embodiments are not limited to CPI pricing, as other pricing models may be used, e.g., CPC (cost per click), CPA (cost per acquisition), CPM (cost per thousand impressions), and revenue sharing. Exchange 212 provides a call back to the winning advertiser broker(s) telling it which ads were displayed, and at what prices.

Architecture 200 also comprises users 214. For purposes of explanation only, only one user will be discussed herein. However, embodiments of the present invention are not limited to a single user, as any number of users may exist. Users 214 request a webpage from publishers 202. The webpage comprises content and advertisement space, which is filled with advertisement(s) from advertisers 206.

Using architecture 200, audience data can be provided to advertisers 206 either by enriching the publishing property with customer intelligence or by acquiring the data directly from audience data broker 210 on the basis of a licensing fee. Advertiser broker 208 can choose to pay an estimated monthly per volume amount for each attribute that their advertisers are interested in targeting. This transaction could be done off-line but would need to be registered with exchange 212 to facilitate data rerouting at request time. Advertiser broker 208 can base its bids on any targeting attributes provided by audience data broker 210. For example, advertisers 206 may place base bids either on a CPC or CPM basis and have the option to incrementally bid for any attribute values exposed to them. Advertiser broker 208 is free to pay higher rates for redundancy or higher data quality. Advertiser broker 208 may manage the risk surrounding assessing individual advertiser performance and converting all bid types to CPI for final ranking by exchange 212. In an embodiment, the pricing model is similar to the pricing models discussed above.

In an embodiment, when publishers 202 have an impression that they are willing to sell (with an optional ask), they can provide a URL and any targetable values to exchange 212. Exchange 212 passes this data and possible additional user data from audience data broker 210 to advertiser broker 208. In an embodiment, advertiser broker 208 ranks the bids of advertisers 206 using any proprietary attributes or techniques that it finds useful. For example, advertiser broker 208 could choose to run keyword extraction or categorization and use this for targeting. Advertiser broker 208 would output a CPI ranked list of advertisers (in an embodiment, the number would be equal to the number of ads requested by the publisher), where the CPI value would already be stripped of any costs used for purchasing audience data. In an embodiment, where multiple advertiser brokers exist, exchange 212 then ranks all ads across all advertiser brokers and chooses the best one (as measured by CPI). If these ads meet or exceed the publisher ask, then exchange 212 proxies a display of the ads on the publisher website.

A second-price auction can still be applied to facilitate aggressive bidding. Publishers 202 can get paid on a CPI basis. Ad impressions are logged to be used for traffic volume calculations used for audience data licensing. In an embodiment, exchange 212 may be used to gate user information originating from publishers 202. Publishers 202 can choose to enrich their property with user data and share this information only with selected advertiser brokers.

To facilitate participants of all types to become part of architecture 200, it may be desirable to establish a pricing model that is extremely flexible, yet at the same time does not change the industry paradigm so greatly as to create confusion that would prevent potential participants from joining architecture 200. Advertisers are already accustomed to both CPC and CPM pricing, with a small but increasing market for CPA (cost per acquisition) pricing. Publishers tend to prefer CPM pricing, and the larger, more complex publishers sell traffic broken down by user demographics and in other ways. Smaller publishers generally have to accept what they can get, which often results in CPC or CPA pricing. Profile owners, such as audience data brokers, have not typically been able to capitalize on their data, and when they have, have done so in flat transactions for aggregate data.

To support the flexibility of all of these pricing models, and even to allow for others in the future, in an embodiment, exchange 212 is based on a CPI model between publisher broker 204 and advertiser broker 208, where, on each request, publisher broker 204 will set a minimum ask, i.e., reserve price, for their available ad space, and advertiser broker 208 will place a bid on the right to have their ads displayed on this request. As discussed above, embodiments are not limited to CPI pricing only. Exchange 212 will take a small portion of the revenue flowing through it to support its operations, which can either be implemented via incrementing the publisher ask by some percentage, or by making agreements with publishers 202 that some percentage of the revenue generated from their traffic will be held back.

Because publishers 202 are concerned with user satisfaction, they would prefer to have some control over the relevancy of the ads placed on their site. Click-through rate is considered a good measure of relevance and therefore many publishers might want minimum click-through guarantees on the ads. Exchange 212 allows publishers 202 to optionally specify a minimum click-through rate that is acceptable. Exchange 212 monitors advertiser broker 208 to make sure that if it wins these types of asks, then it is meeting the performance guarantees. In an embodiment, if an advertiser broker consistently provides low click-through rates for publisher asks that require a minimum, exchange 212 may take punitive measures such as suspension from the system.

Advertiser broker 208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 208 could multiply the conversion rate by the per conversion bid of the advertiser. The more information available in each request, the better job advertiser broker 208 can potentially do in predicting the probability of a click or a conversion. Since it is expected that advertiser broker 208 will therefore desire additional information along with each request to help it predict what those probabilities are, as well as to allow the advertiser to express a preference for one or another of those attribute values by bidding differently, they will want to have information from audience data broker 210 at request time. The pricing model between audience data broker 210 and advertiser broker 208 will be a market, where audience data broker 210 sets minimum guarantee asks, as well as CPM pricing rates. In an embodiment, advertiser broker 208, if it wishes to use audience data broker 210's information, will agree to pay the greater of the guarantee amount or the CPM rate for the number of ad impression auctions that it wins. Exchange 212 is necessary to this transaction so as to track the number of ad impression auctions advertiser broker 208 wins, as well as to query for an attach audience data broker 210's user information to the request sent to advertiser broker 208.

The entity hosting exchange 212 has access to all data sources, giving it the power to make partial decisions. To alleviate the concern that exchange 212 will not be impartial both as hosting body and as a direct participant, in an embodiment, transparency will be built into exchange 212. In that embodiment, exchange 212 does not have a way to identify brokers of any kind. Also, in that embodiment, advertiser auction algorithms and advertiser to publisher and audience data broker matching algorithms are standardized and transparent to all exchange participants. In an embodiment, no user identifiable information is sent to advertisers 206 until the user performs an action. Exchange 212 passes advertiser broker 208 only the attribute values. Advertisers 206 do not see the user identifier. At click-time, however, it is still possible for an advertiser to establish a user identifier and associate the bidding profile with that user. By participating in architecture 200, audience data broker 210 is explicitly sharing its information with advertiser broker 208. Although some leakage is inevitable whenever targeting is permitted (e.g., if a user is targeted and clicks on an ad, the advertiser can correlate and store the targeting attributes for that user), providing audience data from every ask to advertiser broker 208 for bidding purposes exacerbates the problem. However, this can be addressed by centralizing the auction system at the exchange level by requiring that advertiser broker 208 specifies a value function that is evaluated for each ask on exchange 212. For example, exchange 212 could require a linear value function, and advertisers 206 would specify a base bid and a bid increment for each attribute value. Exchange 212 would control the instantiation of the audience data, thus not leaking any to advertiser broker 208.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Additionally, exchange 212 will log all views where user data was used to enrich targeting and help audience data broker 210 enforce the licensing fees. Borders as a publisher has a user requesting the page on the “Lonely Planet Guide to Indonesia” and they would like to show ads on that page. They call exchange 212 with the page URL and information about the user: “Bought four travel books in the last month,” “Bought a book on Bali in the last month,” and “Has clicked on ads before.”

Given the URL, exchange 212 extracts keywords (“Bali vacations,” “Indonesia travel,” “exotic vacations,” “beach vacations”), categories (“travel,” “vacations”) and proxied user data information (coming from the licenses with audience data broker 210), and sends this information to each advertiser broker. Each advertiser runs an auction for the impression. The advertiser broker can choose to ask for aggregate bids from advertisers and subtract the audience data broker licensing fees at the time of the impression. For example, Expedia might place an aggregate bid of 24 cents, and after subtracting the licensing fees, their base bid would be equal to 20 cents. Expedia's advertiser broker needs first to subtract all incremental bids and to assign credit to the publisher or audience data broker as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. Neither the publisher, nor the audience data brokers were able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents. Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad gets served on Border's page. The user clicks on the ad. The user buys a two-week vacation to Bali.

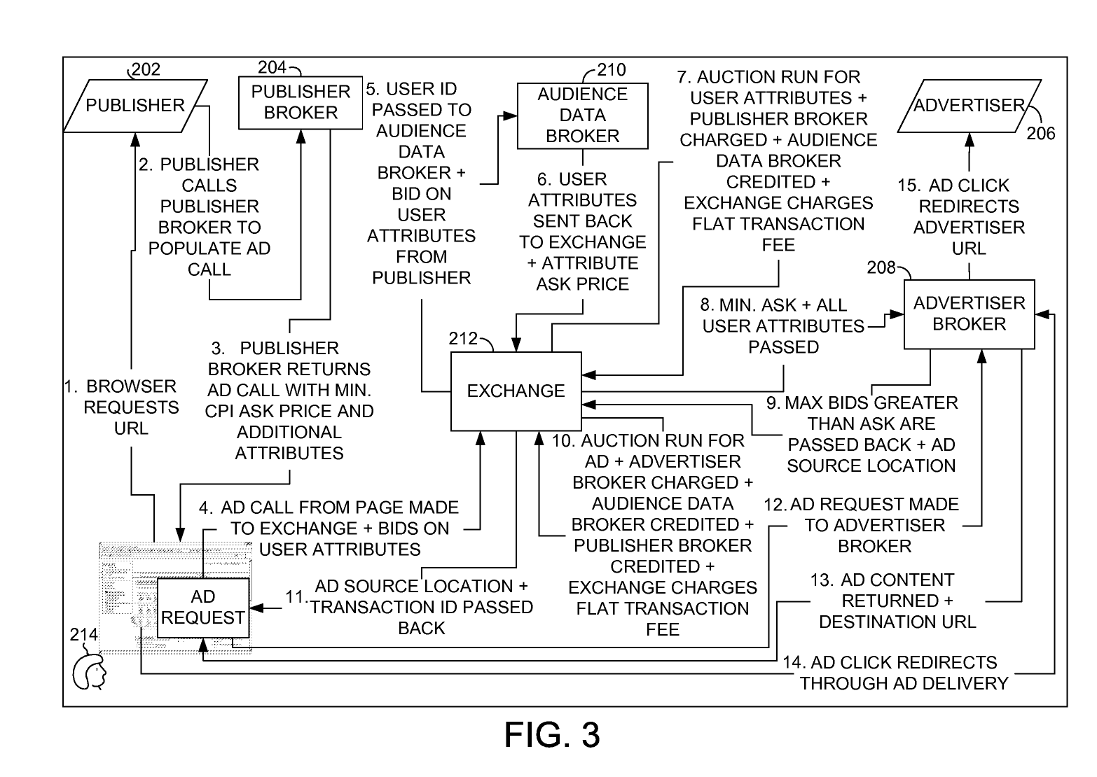

FIG. 3 illustrates one example of the flow of data within architecture 200, according to embodiments of the present invention. Referring to FIG. 3, user 214 opens a browser and requests a URL of a webpage from publisher 202 (1). In an embodiment, the webpage has some advertisement space available, which publisher 202 desires to sell to an advertiser. Publisher 202 calls publisher broker 204 to populate the ad call (2). Publisher broker 204 returns the ad call with a minimum CPI ask price and additional attributes (as discussed in greater detail above) (3). The ad call is made to exchange 212 along with bids on user attributes and a user identifier (4). Exchange 212 passes the user identifier and the bid on attributes to audience data broker 210 (5). In an embodiment, audience data broker identifiers are stored on the user-side and are sent with the ad call to exchange 212 so that exchange 212 can identify which audience data broker(s) may have information about the user. Audience data broker 210 looks up the user identifier and responds with the corresponding attributes along with an attribute ask price (6). In an embodiment, exchange 212 runs an auction for the user attributes, charges publisher broker 204, credits audience data broker 210, and holds back a flat transaction fee (7). Exchange 212 passes a minimum ask plus all user attributes to advertiser broker 208 (8). Advertiser broker 208 responds with all of the bids that are greater than the ask, along with the ad source location (9). In an embodiment, exchange 212 runs an auction for the ad, charges advertiser broker 208, credits audience data broker 210 and publisher broker 204, and holds back a flat transaction fee (10). Exchange 212 passes the ad source location and transaction identifier back (11). An ad request is made to advertiser broker 208 (12), which responds with the ad content and a destination URL (13). If user 214 clicks on the ad, the user is redirected by advertiser broker 208 (14) to advertiser 206 (15). The above example illustrates just one embodiment of the present invention. Other embodiments may not involve the same operations or conduct them in the same order. Specifically, other examples may not supplement with data from audience data broker 210. Other examples may not rely on auctions to set prices, instead relying on a firm ask that can be accepted or declined.

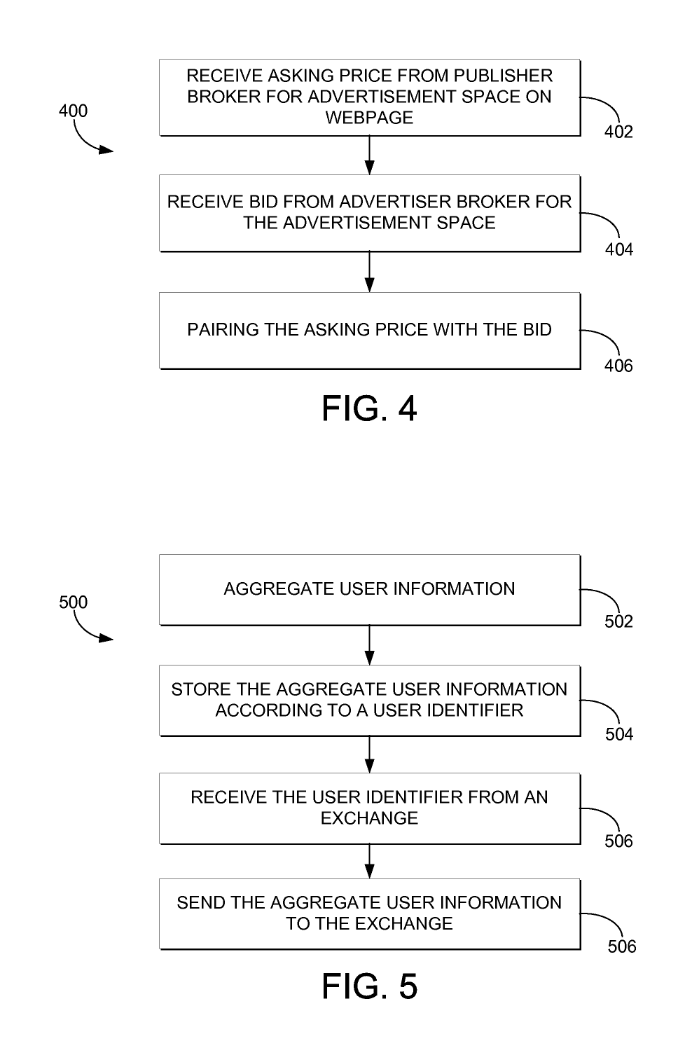

FIG. 4 illustrates a flowchart of the operation of an exchange, according to embodiments of the present invention. Referring to FIG. 4, method 400 begins with the receipt of an ask from a publisher broker for advertisement space on a webpage (402). A bid is received from an advertiser broker for the advertisement space (404). In an embodiment, bids are received from many different advertiser brokers. The ask is paired with one of the bids (406) and the advertisement space on the webpage is awarded to the winning bidder. As discussed in greater detail above, other information such as user attributes may be attached to the ask, and quality of the bidding advertisers may be examined prior to the advertisement space being awarded.

FIG. 5 illustrates a flowchart of the operation of an audience data broker, according to embodiments of the present invention. Referring to FIG. 5, method 500 begins with the aggregation of user information (502). The aggregate user information is stored according to a user identifier (504). When the user identifier is received from an exchange (506), the aggregate user information corresponding to that user identifier is sent to the exchange (508). In an embodiment, the audience data broker may set a cookie on the user computer to identify itself as having information about that user. When the exchange reads that cookie, it knows which audience data brokers to query for information about the user.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

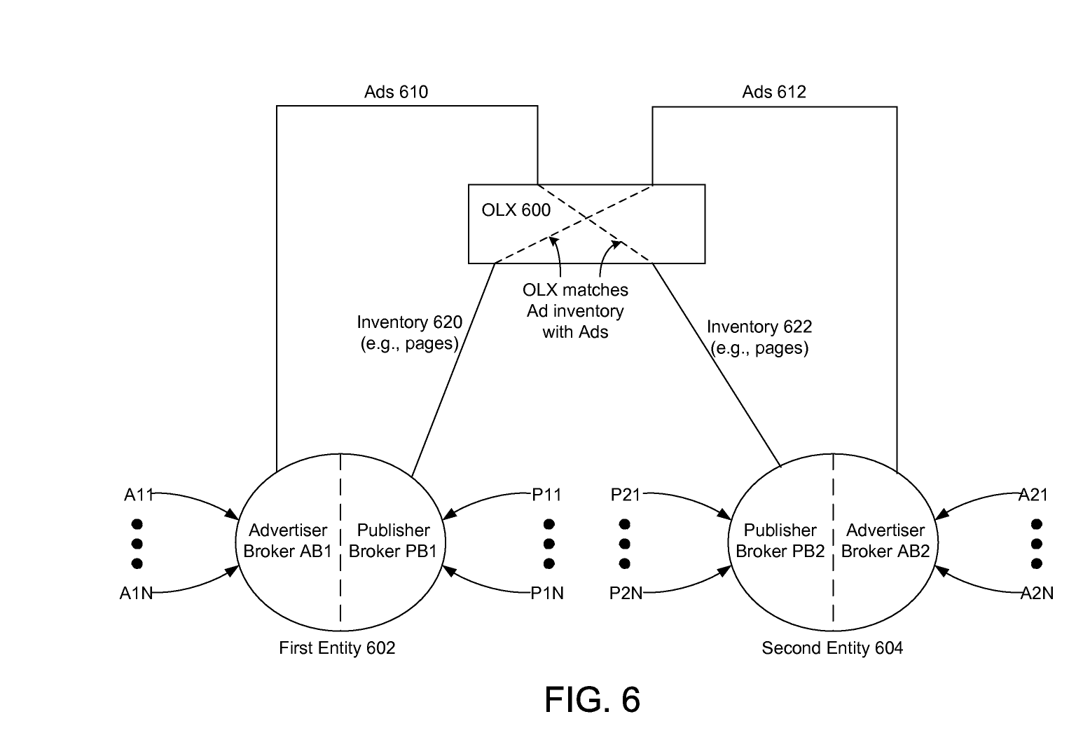

The invention thus can operate in a system that enables broad liquidity over distributed advertising markets, such as the above-described advertising exchange systems. FIG. 6 illustrates a conceptual block diagram of an on-line advertising exchange 600 provided in accordance with the invention. As shown, a first entity 602 and a second entity 604 are subscribers to the services of exchange 600. First entity 602 may have an advertiser broker AB1 for brokering advertisements 610 from a variety of sources A11 thru A1N and a publisher broker PB1 for brokering inventory 620 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 604 may have an advertiser broker AB2 for brokering advertisements 612 from a variety of sources A21 thru A2N and a publisher broker PB2 for brokering inventory 622 from a variety of publishers P21 thru P2N.

In accordance with the invention, by providing ads 610 and 612 to OLX 600 according to a first communications layer, and by providing inventory 620 and 622 to OLX 600 according to an independent communications layer, OLX 600 can efficiently match advertisements to available inventory with greater simultaneous knowledge of multiple advertising networks with respect to user attribute spaces.

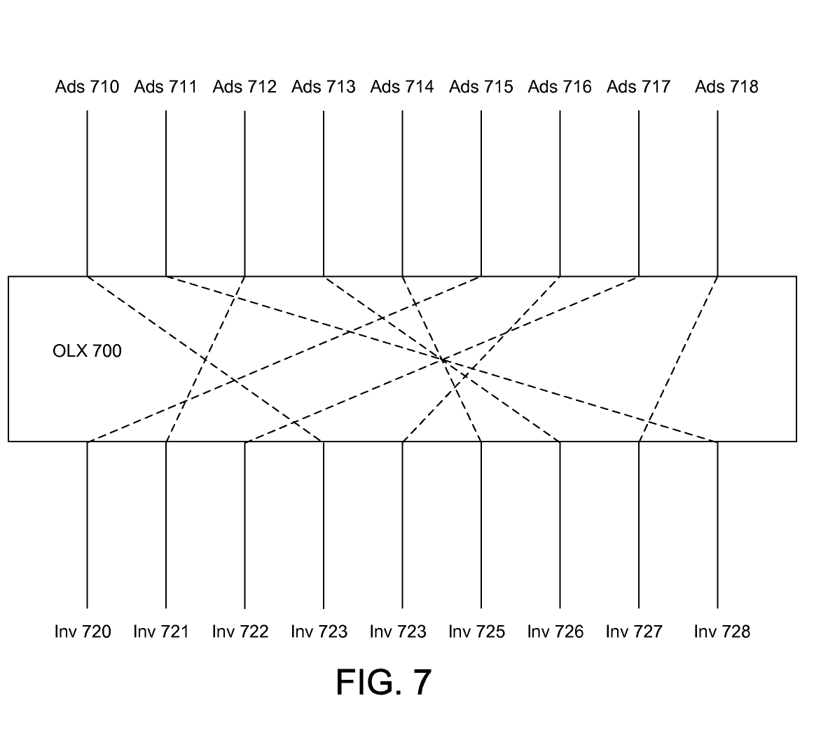

For instance, first entity 602 might be Microsoft's MSN Web site, and second entity 604 might be Yahoo's portal Web site. For simplicity, FIG. 6 illustrates only two entities, but advantageously, the invention can also be scaled to accommodate any number of advertising networks, e.g., eBay, Amazon, Google, etc. This is illustrated in FIG. 7 showing an OLX 700 that accommodates a wide range of advertising 710, 711, 712, 713, 714, 715, 716, 717, 718, etc. from a wide range of parties, and also accommodates a wide range of inventory 720, 721, 722, 723, 724, 725, 726, 727, 728, etc. from a wide range of parties. OLX 700 then makes the best assessment of how to match advertising content with inventory according to a variety of policies (e.g., maximizing ad revenue, maximizing quality of advertising, maximizing conversion rate, etc.). In accordance with embodiments of the invention, OLX 700 then makes the best assessment of how to match advertising content with inventory according to a variety of policies having to do with the user attributes for a given advertising medium. While various non-limiting embodiments of the invention are described in the context of two parties herein, this is for ease of conceptual presentation and it can be appreciated that the invention can be provided for any arbitrary number of advertising entities, publishing entities and audience data brokers wishing to join the exchange 700.

Having thus described an exemplary advertising exchange environment, various non-limiting embodiments of the normalization and tracking of user attributes for participants of an advertising exchange or advertising framework in accordance with the invention are now presented in more detail below.

### Normalizing User Attribute Spaces and Tracking Performance of Sets of User Attributes

As mentioned, the invention enables each participant to a multi-party advertising exchange to expose one or more user attributes of a user attribute space represented by publishing inventory to the exchange, which normalizes the user attributes to a common vocabulary for describing the user attributes within the exchange. The disparate user attributes of multiple participants are thus normalized within the advertising exchange by mapping, via a mapping function, the user attributes to the elements of the common representation of user attributes within the exchange enabling the comparison or translation of a first set of user attributes to a second set of user attributes via the common representation.

In this regard, any class of user attributes for which differences may exist across different advertising networks can be normalized by the exchange of the invention during the matching process for matching advertising inventory with advertising purchasers. Other user attributes that may be of interest to an advertiser include, for example, whether the user is known to have recently pre-qualified for a car (i.e., and thus has an interest in cars and a certain good credit rating). Such information about user attributes can be of high interest to some advertisers, and can be captured in the advertising matching process performed by the exchange of the invention, or by an audience data broker as described above.

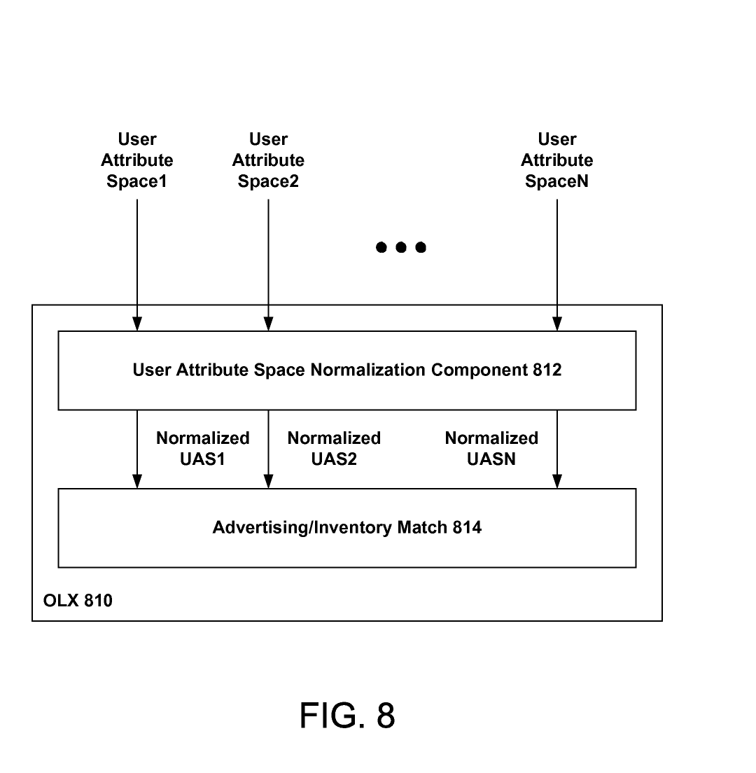

As shown in FIG. 8, the different categories, metrics and/or definitions associated with user attribute spaces of different publishers are input to a normalization component 812 of online exchange 810, which analyzes and normalizes the user attribute space1, space2, . . . , spaceN to a common set of user attributes represented within the exchange 810. The user attribute spaces are converted to the common standard, and the resulting normalized user attribute space UAS1, UAS2, . . . , UASN can then be used by matching process 814 on an “apples versus apples” basis so that different user attribute spaces of a variety of brokers can be compared directly when determining price comparisons by the exchange process 814 according to the common standard for defining user attribute spaces. The invention thus operates as a broker Rosetta stone that operates independently of multiple advertising networks to translate among different user attribute spaces to enable a universal advertising currency.

Accordingly, the invention provides a federated approach to disparate advertising brokers and publisher brokers in contrast to the proprietary closed advertising networks of the past. As additional ad networks join the exchange program of the invention, the power of the market increases because with more information about the performance of sets and subsets of user attributes, information about the real-time value of advertising can be made more precise with an increasing view of the larger picture formed by each participant relative to user attributes.

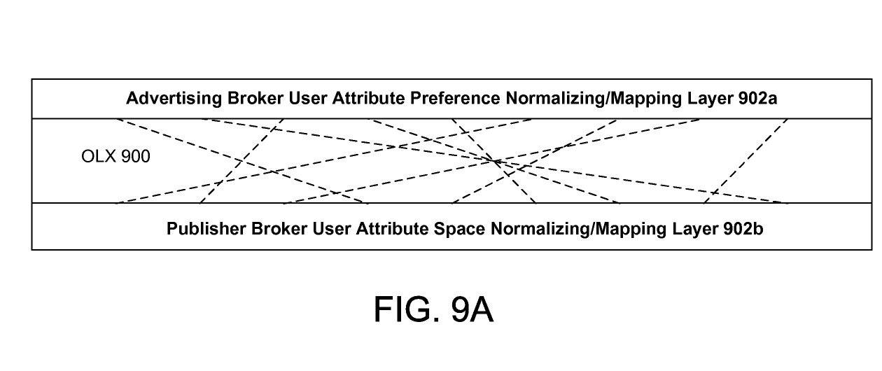

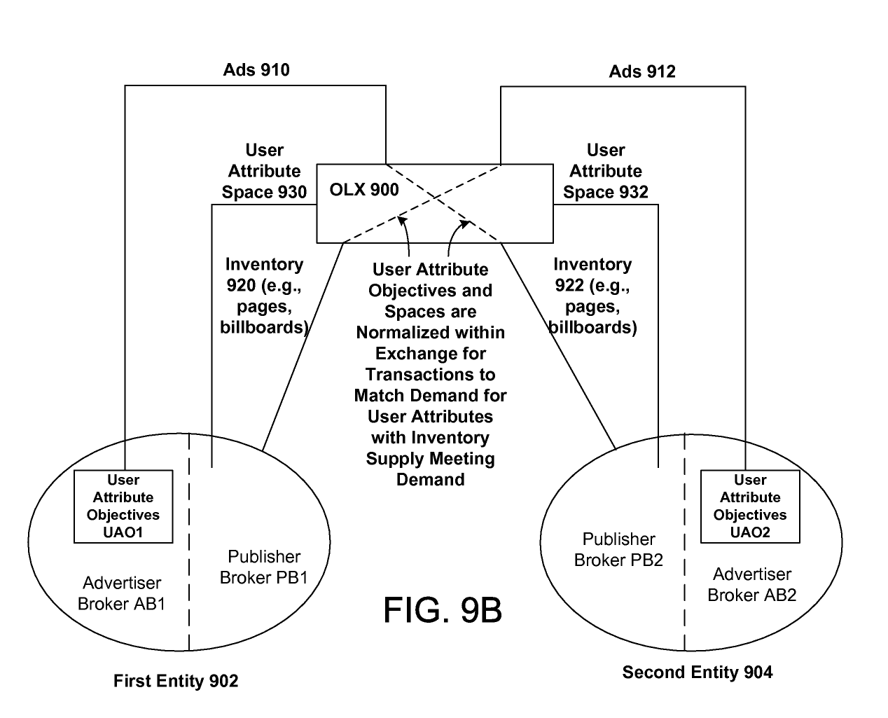

In this regard, objectives for user attributes by an advertising entity can include any arbitrary function that is based on a user attribute variable for any kind of advertising product. This is illustrated conceptually by exchange 900 depicted in FIG. 9A. As shown, for user attributes defined by advertising brokers for their advertising entities, a mapping/normalizing layer is shown as a first layer 902a before matching content takes place in order to normalize user attribute preferences to the common set of user attributes for transactions in the exchange 900. In addition, another layer 902b normalizes user attribute spaces received from publisher brokers for the inventory of publishers represented in the exchange 900. Once normalization occurs in layers 902a and 902b, exchange 900 operates as described elsewhere herein to match supply of advertising inventory to demand by advertisers for the inventory based on user attributes specified by the parties. In one embodiment, the normalization process is made blind to the identities of the parties' involved in order to ensure a fair and objective normalization of user attributes.

FIG. 9B illustrates an exemplary non-limiting embodiment of the invention that provides the ability to balance objectives of advertiser brokers AB1, AB2 with respect to preferences for user attributes of the audience of prospective inventory for advertising transactions. Each advertising entity is provided with the ability to create and modify their user attribute objectives for input to the exchange 800. First entity 802 thus has a set of user attribute objectives UAO1 and second entity 804 has a set of user attribute objectives UAO2, which allow the advertiser brokers of entities 802 and 804 to fine tune their preferences with respect to user attributes of inventory 820, 822 in the exchange 800 in accordance with the invention.

Receiving user attribute objectives UAO1 and user attribute objectives UAO2, exchange 800 automatically operates to normalize UAO1 and UAO2 to a common vocabulary within exchange 800 and helps to facilitate matches between advertisers and publisher inventory based on a comparison of user attribute objectives. This operates to balance the objectives based on a comparison of user attribute objectives, requirements or criteria so that all parties are satisfied with the representations made with respect to user attributes for a prospective audience for advertising.

The exchange 800 thus, in effect, helps to place a premium on publisher inventory when specific user attribute requirements are met by the publisher inventory, (and also where such publisher inventory is of limited supply). In this regard, in another aspect of the invention, a publisher may have its publisher inventory pre-qualified for a demographic based on performance information measured by the exchange 800 or audience brokers providing information to the exchange about users of the publishing inventory. Similarly, the exchange 800 in effect taxes or penalizes publisher inventory for which less is known about the publisher's user attribute space. In effect, unknown inventory with an unknown audience is risky and will generally meet limited demand by advertisers, especially where pre-qualified inventory is available to satisfy their desires. The invention thus provides a taxation method to user attribute objectives of buyers of inventory (advertisers) with user attribute spaces of sellers (publishing entities) in the exchange.

For instance, a concrete example of the operation of such a taxation method would be if Yahoo, as first entity 802 with publisher space, says, “we don't want our ads published in advertising publishing inventory having an elderly audience (e.g., age 80 or higher) in order to maintain our hip and young image.” By defining this user attribute objective in objectives UAO1, this information is taken into account by exchange 800 so that the exchange 800 will not make matches to publisher inventory that meets a definition for elderly advertising inventory. In this respect, if a lot of advertisers do not prefer elderly advertising inventory, a “bad demographic group” tax will be in effect imposed on publishers having such inventory directed to elderly people. Conceptually, each party thus has “knobs” to fine tune the way its advertisements are to be handled by exchange 800 based on desired user attribute of a target audience, which in turn is represented according to the common vocabulary for user attributes within the exchange 800 by normalizing the user attributes specified by the party. Matches are then facilitated by the exchange 800 based on supply and demand for inventory, taking into a comparison of user attribute objectives of the advertisers with the user attribute spaces of prospective publisher inventory. Where enough information is known about the user attribute space of a particular publisher's inventory, the inventory can be pre-qualified by the exchange as described in more detail below.

As mentioned, in exemplary, non-limiting embodiments, the distributed framework for online advertising of the invention enables the specification of preferences for user attributes by advertising entities, i.e., each advertiser can specify respective maximization functions for various user attributes for transactions in the advertising exchange.

In this regard, since each party has unique business goals and objectives, a wide variety of user attribute objectives may be toggled, or modified in accordance with the invention to specify user attribute preferences. For instance, a party can specify a preference for a set of user attributes that maximizes revenue for a given item of inventory, a preference for a set of user attributes that maximizes the relevance of the advertising to a given target audience, a preference for a set of user attributes that will lead to the widest distribution to as many users as possible, or any other parameter or function specified relative to user attributes that indicates a set of preferred user attributes for an audience for advertisements.

Once each advertiser has specified a complete set of desired user attributes that maps to the goals and objectives of the advertiser with respect to advertising, this information is received by the exchange. Since initially, different parties' user attributes may be specified according to different vocabularies, the exchange operates to normalize all of the user attributes of the different parties into a common set of user attributes. The common set of user attributes can be any set of user attributes of lower dimensionality than the user attribute spaces of publishing entities, e.g., a minimum overlapping set of user attributes common to the different parties.

In this regard, confirmed by the variety mentioned above, the number of factors that an exchange participant can vary with the tools of the present invention to personalize objectives for user attributes for advertising are virtually limitless. Also, the factors can be tailored to advertising segments, i.e., banner ads can have different preferences for user attributes than keywords, which have different factors for user attribute than pop-up ads, and so on.

As mentioned, there are a variety of user attribute spaces that may be defined for publishing inventory based on the audience of the publishing inventory in accordance with the invention. Any publisher can input a set of user attributes representing the publisher's user attribute space for transactions in the exchange, and based on known mappings between the common user attribute space and the publisher's user attribute space, user attribute spaces across different publishing entities can be normalized in the exchange, and thus compared.

Furthermore, rather than require an explicit mathematically defined set of user attributes, the tools of the invention optionally allow an advertising entity to express user attribute objectives in terms of business goals, e.g., maximizing revenue, preserving brand name, broadest advertising exposure, most socially responsible advertising exposure, most demographically targeted advertising exposure, policies based on clickthrough/impression/conversion/acquisition probabilities, and the like.

Moreover, performance tracking, such as conversion tracking, as a function of user attributes described in more detail below enables such definition in terms of business goals since past performance of certain subsets of user attributes can be mapped to functions representing such business goals. For instance, performance data can be mined to determine the best set of user attributes for maximizing revenue, for achieving a demographically targeted effect, etc. Additionally, performance data and/or other audience broker data can be used to pre-qualify publishing inventory for a given set of attributes so that prospective advertising entities can be more certain about the user attribute characteristics of such pre-qualified publishing inventory being purchased in advance.

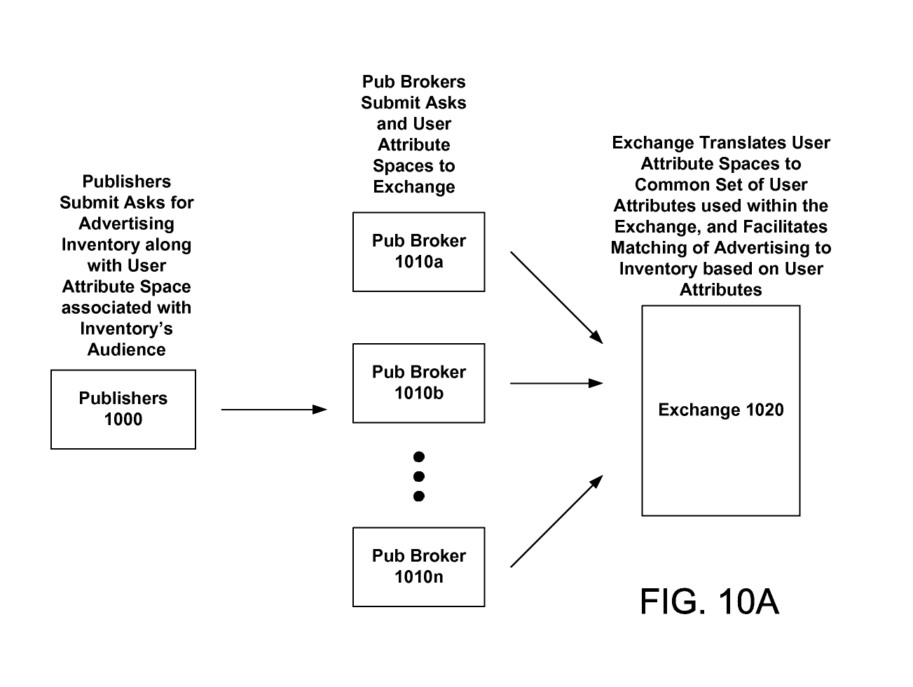

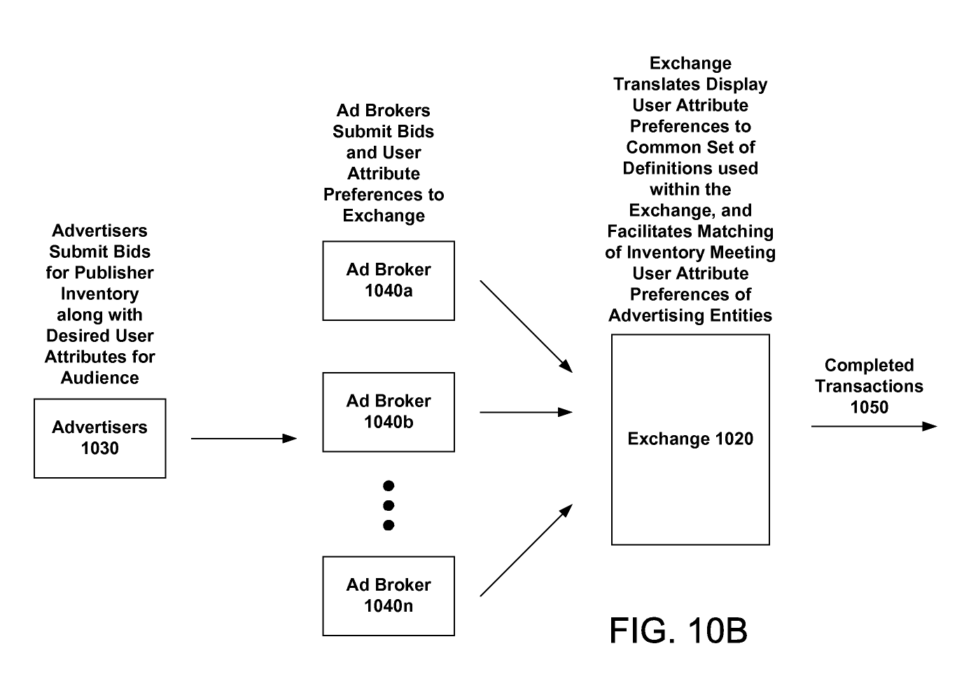

FIGS. 10A and 10B illustrate exemplary normalization of user attributes in accordance with the invention as between advertisers, advertising brokers, publishers, publisher brokers and the exchange that facilitates the normalization of user attributes. In accordance with the invention, preferences for any user attributes can be defined on a per participant basis that map back to business objectives of the advertisers of an exchange. By translating the user attribute preferences to a common vocabulary for user attributes within the exchange, which can be implemented in a myriad of ways, a common ground is defined so that the advertising exchange is grounded end to end by an expectation of user attributes for advertising by all parties to an advertising transaction. The standardized vocabulary the exchange to compare user attribute preferences with available inventory having a matching user attribute space, to facilitate transactions in the exchange.

As mentioned above, the user attribute spaces of publishers and publisher brokers can be normalized to a common vocabulary in the exchange so that apples to apples comparisons can be made among user attribute spaces of publishing inventory when transacting in the exchange. This is illustrated in FIG. 10A where publishers 1000 submit asks for advertising to pub brokers 1040a, 1040b, . . . , 1040n along with a definition describing the way that the user attribute space is represented by the publisher 1000. The pub brokers 1010a, 1010b, . . . , 1010n submit the asks and user attributes space definitions to the exchange 1020, which translates the user attributes space definitions to a common set of user attributes used within the exchange, e.g., a common set of categories or definitions used with the exchange 1020.

Also, as shown in FIG. 10B, advertisers 1030 submit bids for publisher inventory to ad brokers 1040a, 1040b, . . . , 1040n, including preferences or requirements for user attributes for the publisher inventory in the exchange 1020. Ad brokers 1040a, 1040b, . . . , 1040n choose to broker the ad along with the preferences for user attributes. Then, for further transaction in the exchange 1020, the user attributes of the bids for publishing inventory are transformed to a common vocabulary in exchange 1020 that can be used in connection with transactions with publishers selling their inventory. The exchange 1020 also facilitates matching of asks to bids based on display requirements from advertisers 1000 and the definitions from the publishers 1030. This results in completed transactions 1050 that are matched based on user attributes.

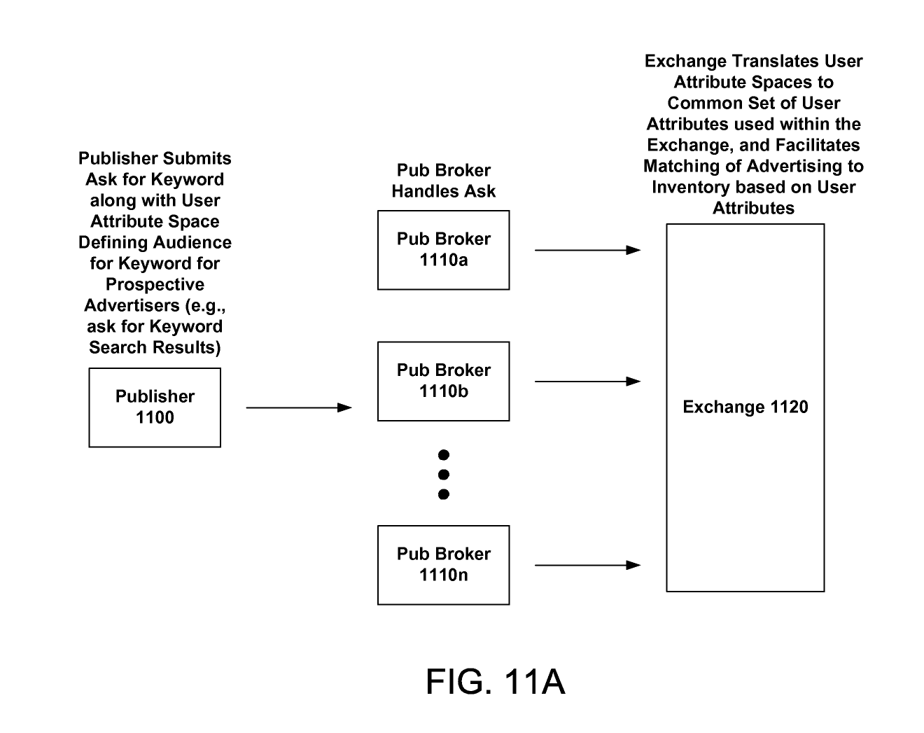

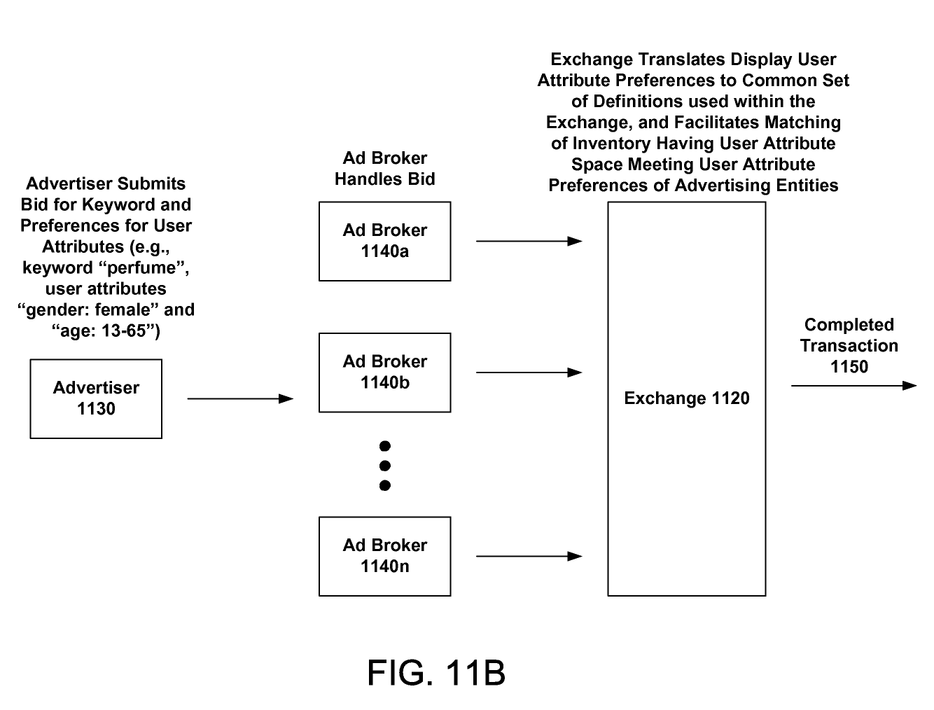

FIGS. 11A and 11B illustrate exemplary, non-limiting operation of the invention in the context of keyword bidding. As shown in FIG. 11A, publishers 1100 submit asks for the advertising inventory (e.g. Search results based on keywords) to pub brokers 1110a, 1110b, . . . , 1110n along with a definition for a user attribute space that corresponds to the target audience of the publisher's search engine. The pub brokers 1110a, 1110b, . . . , 1110n submit the asks and user attribute space definitions to the exchange 1120, which translates the user attributes definitions to the common vocabulary used with the exchange 1120.

As shown in FIG. 11B, advertisers 1130 submit listings with bids for keywords to Ad Brokers 1140a, 1140b, . . . , 1140n, which may include a requirement that advertising based on the keyword “Perfume” be displayed only to a target audience having user attribute requirements: gender→female and age: 13-65. Any of ad brokers 1110a, 1110b, . . . , 1110n handle the bid and the exchange defines the bid for the keyword “perfume” along with the user attribute requirements as normalized to the common representation for user attributes within the exchange 1120 The exchange 1120 then facilitates matching of asks to bids based on user attribute requirements from advertisers 1100 and the definitions of user attribute spaces from the publishers 1130. This results in completed transactions 1150 that are matched based on user attributes. In this example, a transaction 1150 is completed that matches publisher inventory that meets the “gender→female and age: 13-65” attribute requirement of the advertiser for keyword “perfume.”

As mentioned, in further embodiments, performance tracking is enabled for sets and subsets of user attributes to provide a more solid understanding of conversion rate for advertising in the presence of different audiences because the information is provided across advertising networks and across different parties. In an exemplary, non-limiting embodiment, conversion tracking is enabled as a type of performance tracking for the exchange, though clickthrough rate, or any other type of information that would tend to reduce the variance associated with a given target demographic would be beneficial to have in accordance with the user attribute space of the invention. Where conversion information is being tracked, an audience broker can keep track of such conversion information and/or such information can be recorded within the advertising exchange. In essence, it is known that by increasing one's conversion rate for advertising, a marketer can lower the cost per acquisition without changing the cost paid for traffic. Even a small increase in conversion rate can have a dramatic profit impact, and so it is desirable to find publishing space with user attribute characteristics having a high expected conversion rate.

Also, with conversion tracking provided in the distributed framework for online advertising in accordance with the invention, pricing can be made more accurate because conversion information about how different subsets of user attributes perform is available across a large number of parties, averaging out individual transactional biases with respect to user attributes within an advertising network. Moreover, individuals can better understand how the same advertisement performs under different user attribute characteristics to better understand the best audience for display of a particular advertisement type.

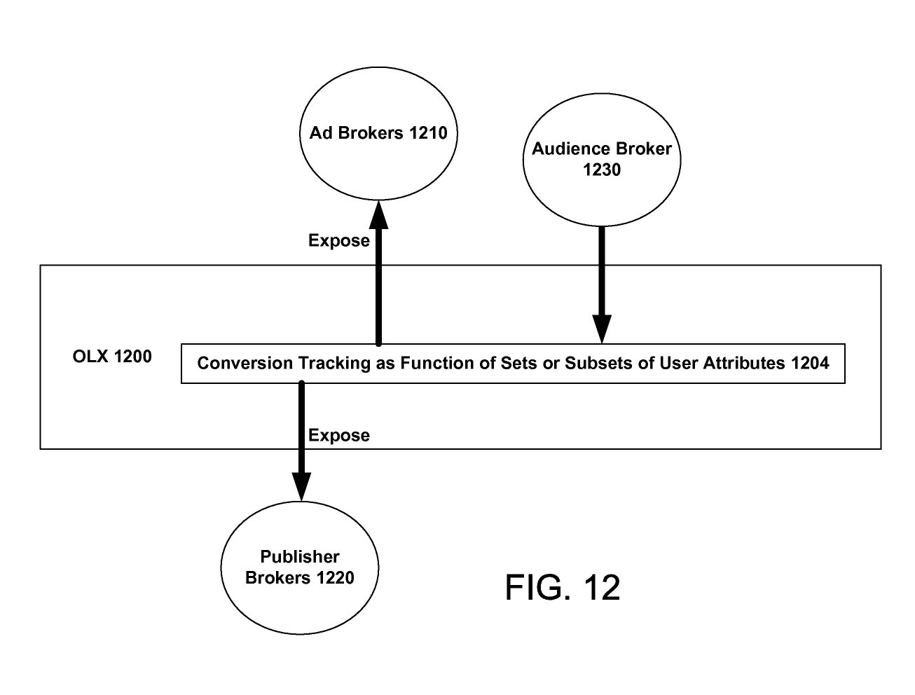

The federated nature of the exchange of the invention thus makes a host of information available, and the normalization of user attribute spaces to a common set in accordance with the invention enables comparisons of user attribute spaces. Furthermore, conversion tracking across different advertising networks can be achieved for a more holistic view of conversion rates for different advertising products under different sets and subsets of user attributes for a target audience. As shown by the online advertising exchange (OLX) 1200 of FIG. 12, the invention thus includes the ability to aggregate conversion rate information from disparate sources, either transaction data tracked within the exchange 1200 or any user attribute or other conversion information received from one or more audience brokers 1230.

By collecting conversion rate information via a common tracking component 1204, a real-time accurate view is enabled over conversion rates across the exchange for different sets or subsets of user attributes, and any functions based on the sets or subsets of user attributes. Then, the conversion information can be exposed to ad brokers 1210 or publisher brokers 1220 in a format that relates the conversion information to corresponding user attributes of relevance to their participation in the exchange 1200. As will be observed below, the conversion rate information can also be used to pre-qualify publishing inventory for a certain class of audience (i.e., for a given set of user attributes represented within the common set of user attributes represented in the exchange 1200).

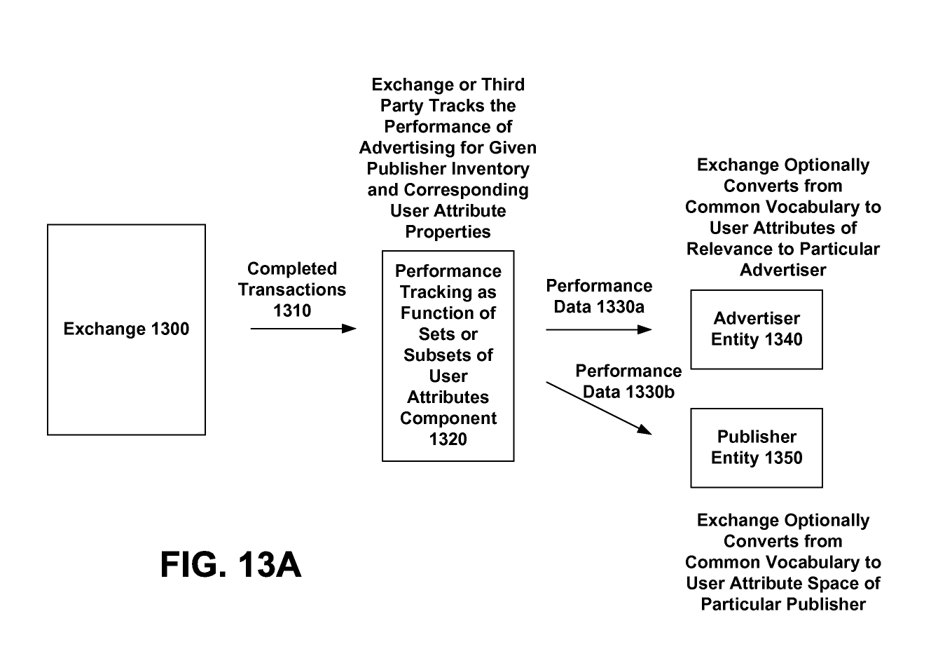

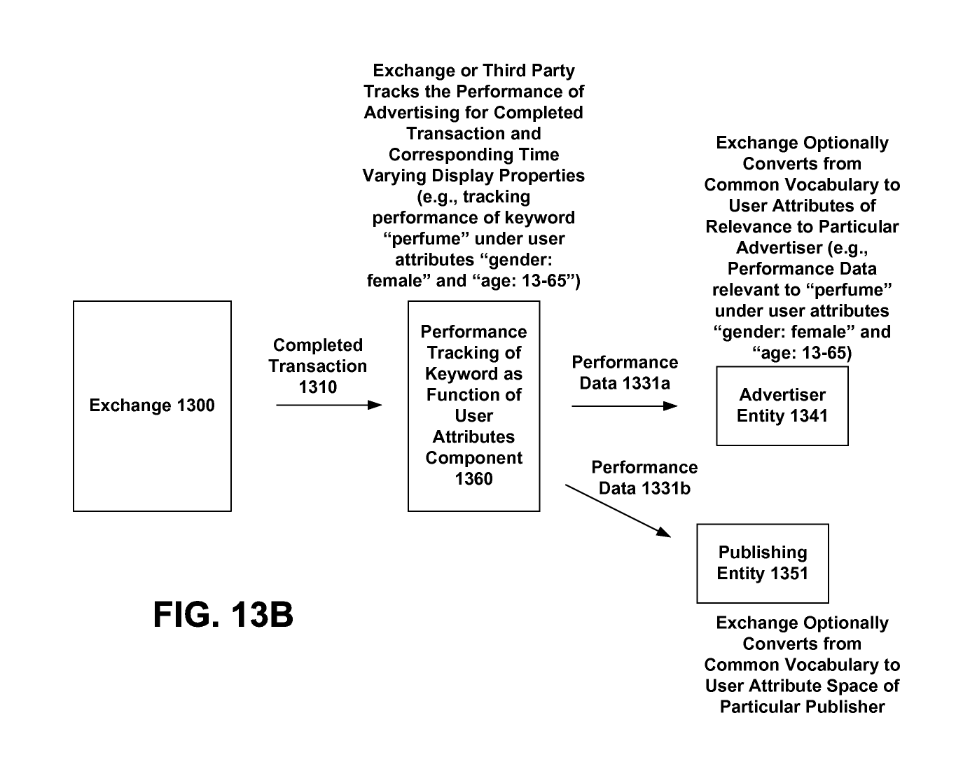

FIG. 13A illustrates how the common vocabulary of the exchange 1300 can be used after transactions 1310 are completed. In accordance with another exemplary, non-limiting aspect of the invention, conversion tracking by a performance tracking component 1320 is automatically enabled for completed transactions 1310 that determines how the advertising performs as a function over time and changes to the user attributes associated with the audience of the advertising. For instance, when an audience of a first set of user attributes views advertising on a first day, and an advertisement performs according to a first statistical curve with respect to conversions, and then when an audience of a second set of user attributes is used on a second day for the same advertisement, the advertisement performs according to a different statistical curve, data is explicitly and implicitly collected about the performance of the first set of user attributes relative to the second set of user attributes.

This performance comparison enables a more granular pricing based on the user attributes of inventory desired for advertising transactions. The performance information 1330a and 1330b aggregated by performance tracking component 1320 can also be exposed to the participants to the transaction, i.e., the advertiser entity 1340 and publisher entity 1350, so that the participants can better understand their transaction tradeoffs as time progresses.

FIG. 13B illustrates how the common vocabulary for user attributes of the exchange 1300 is then used after the transactions 1310 are completed between advertiser entity 1341 and publishing entity 1351 in the context of keyword bidding. In accordance with another exemplary, non-limiting aspect of the invention, conversion tracking by performance tracking component 1320 is automatically enabled for the completed transaction 1310 that determines how the advertising performs over time as a function of the keyword and user attribute space of the publisher of the search results page. The performance tracking component 1320 also captures changes to the user attributes that occur over time to the extent that the statistical characteristics of the publisher's audience changes significantly over time.

For instance, whenever a user enters the relevant keyword(s) to the publishing entity's Web page as part of search results, the publishing entity 1351 will publish the advertisement of advertiser 1341. The performance tracking component 1320 tracks the performance of the top banner ad over time as these keyword events occur, as a function of user attributes, and aggregates data and trends about how sets and subsets of user attributes are performing. Also, if the publishing entity 1351 changes its user attribute space significantly over time, the performance tracking component 1320 will track the changes and record the impact of the user attribute changes to the performance of the advertising.

This performance comparison enables a more granular pricing based on the user attributes required for advertising transactions. The performance information 1331a and 1331b aggregated by performance tracking component 1320 can also be exposed to the participants to the transaction, i.e., the advertiser entity 1341 and publisher entity 1351, so that the participants can better understand their transaction tradeoffs as a function of user attributes.

In one embodiment, a modifier is specified as a discount rate, i.e., if a publisher is known to have a bad conversion rate for its user attribute space for its publishing inventory, the publisher's inventory can be discounted in a way that is proportional to the modifier. As the publisher's conversion rate becomes better and better, the modifier improves for the publisher, i.e., the exchange dynamically prices that publisher's space at a higher premium to recognize the improvement in quality of user attributes of the inventory. Similarly, if a publisher's quality of user attribute begins to fall, the exchange of the invention will dynamically lower the price for that publisher's inventory.

Initially, not a lot will be known about the conversion rate of an unknown publisher, however, by analyzing the user attributes of the unknown publisher's inventory, past history of conversion information based on display characteristics can be used to predict the quality of performance of advertisements. In addition, as described above, the publisher can provide an explicit definition of its user attribute space to the exchange that is normalized within the exchange. In this respect, the exchange of the invention can operate as an independent referral or validating source for quality user attribute spaces by pricing inventory that reveals user attribute characteristics that yield high conversion rates at a higher rate (e.g., 20%) than inventory with no user attribute characteristics specified.

In one non-limiting implementation, a non-linear curve is adopted to weight conversion rate based on certain user attribute characteristics as more important when matching advertisements to publishers by the exchange of the invention. While conversion rate has historically been used as a linear factor in pricing an advertising product, applying a non-linear curve based on clickthrough rate as a function of sets and subsets of user attributes can serve as a corrective market force, rewarding publishers that can maintain a high quality audience.

In this regard, any non-linear weighting scheme can be applied based on a proxy for conversion rate for publishers or advertisers in accordance with the exchange of the invention, and as described earlier, such weighting scheme can be specified as part of an entity's personal user attributes. Some advertisers, for instance, may wish to specify that they are particularly averse to (i.e., wish to penalize in a non-linear manner) advertising in spaces with certain user attribute(s), or alternatively, wish to only advertise in spaces with other user attribute(s). Such penalties on publisher inventory with low conversion rates operates as a lever on the free market forces that normally would apply to matching advertisements with inventory by the exchange of the invention. As a result, publishers have an additional incentive to keep a high quality audience in order to help avoid low conversion for ads coupled to the content, having a beneficial effect on the overall user experience of online advertising as encountered by users as well.

In other exemplary non-limiting embodiments of the invention, temporal aspects or other changes over time to the user attribute spaces of publishers are automatically tracked in accordance with the conversion tracking based on user attributes in accordance with the invention. For instance, user attribute curves can be applied over time to inventory so that certain inventory is priced properly in accordance with temporal events that affect the user attributes of presenting a particular advertisement. For instance, a switch from George Bush on the front cover of a newspaper to Tiger Woods may indeed trigger a significant change in audience profile. In such case, the invention can operate to automatically reprice the display of the advertisement in accordance with a lower conversion rate. Accordingly, in various non-limiting embodiments, the exchange of the invention operates to normalize pricing for inventory based on temporal variation of user attributes of an audience that affect conversion rate for the advertising.

As mentioned earlier, the exchange of the invention operates to normalize user attributes preferences and spaces as between a whole host of publisher brokers and advertiser brokers, and in doing so, creates a market for the exchange of advertising products according to different sets and subsets of user attributes, including futures market pricing for those sets and subsets. Forecasting information can thus be applied by the exchange of the invention when setting a price for online advertising futures for any of the sets and subsets as well.

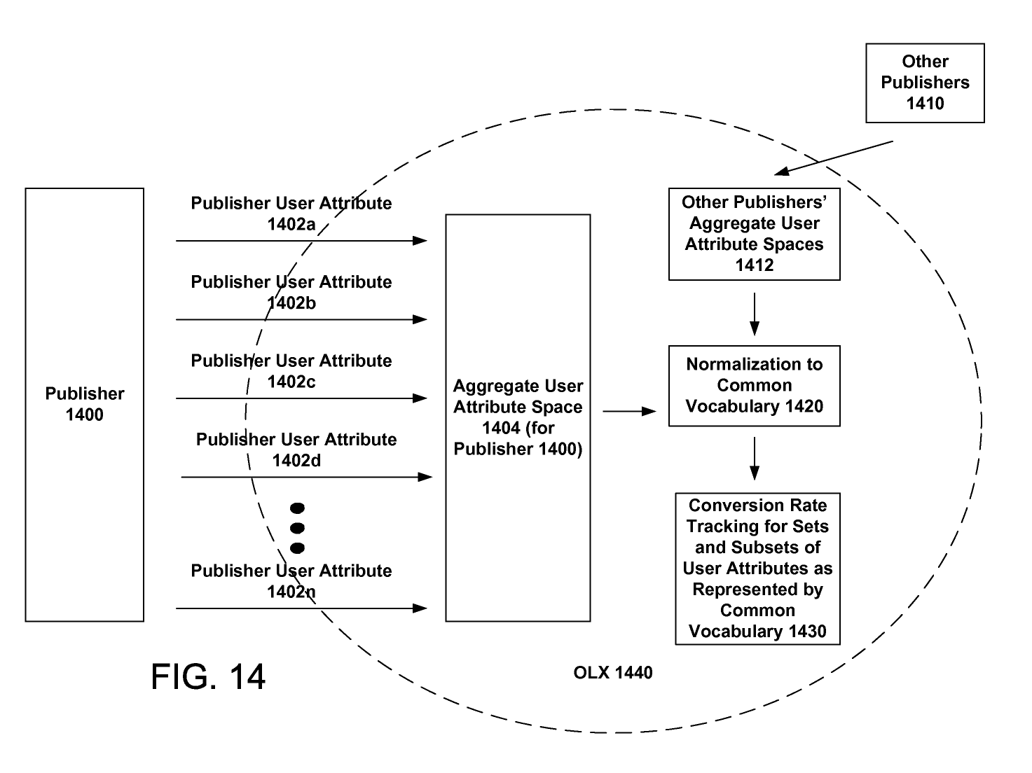

As mentioned earlier, the invention provides a variety of tools, user interfaces, application programming interfaces, etc., that enable each publisher participating in the exchange to authenticate their presence on the advertising exchange, and express their user attributes space(s) for their publishing inventory. FIG. 14 is a block diagram that shows the ability of publishers to specify one or more user attributes to an advertising exchange or federation 1440 in accordance with the invention. A publisher 1400 can specify a variety of user attributes 1402a, 1402b, 1402c, 1402d, . . . , 1402n to form an aggregate or collective user attribute space 1404. The publisher user attributes 1402a, 1402b, 1402c, 1402d, . . . , 1402n can be specific to a kind of inventory, and may be specified according to any granularity to the exchange 1440.

Similarly, other publishers 1410 can each specify their user attributes for advertising transactions via effective user attribute spaces 1412. With each of the publishers' user attribute space(s) mappable to the common representation of user attributes in the exchange, the invention can normalize the user attribute spaces of the publishers participating in the exchange 1440, so that the transaction costs due to the participants' preferences can be understood for a given transaction. Once normalized by component 1420, transactions are completed in the exchange 1440 based on mapping advertiser bids to applicable inventory having certain user attribute spaces. Then, conversion rate information is tracked by a component 1430 for sets and subsets of user attributes as described above.

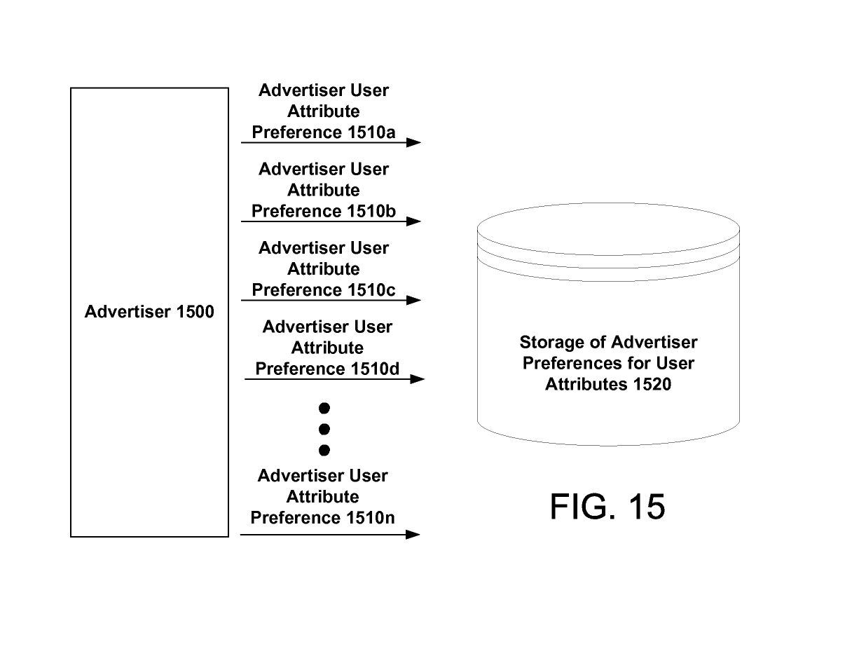

FIG. 15 is a block diagram illustrating that an advertising participant 1500 can make choices for user attributes 1510a, 1510b, 1510c, 1510d, . . . , 1510n, which can be stored in storage of user attributes 1520 that efficiently enables mapping to the common user attribute expressions used in the exchange.

There are many different ways in which a participant can express a user attributes. The expression can be direct (“I will not display my hockey stick advertisements to elderly people”) or indirect (“I will not display my charity foundation advertisements at pornographic publishing sites”, which implicates a certain audience demographic). Such examples show binary user attributes where a participant expresses a preference in one direction or the other. User attributes can also be expressed along a continuum, or according to any function f(x), as long as the expressions are translatable to the common set of user attributes represented in the exchange.

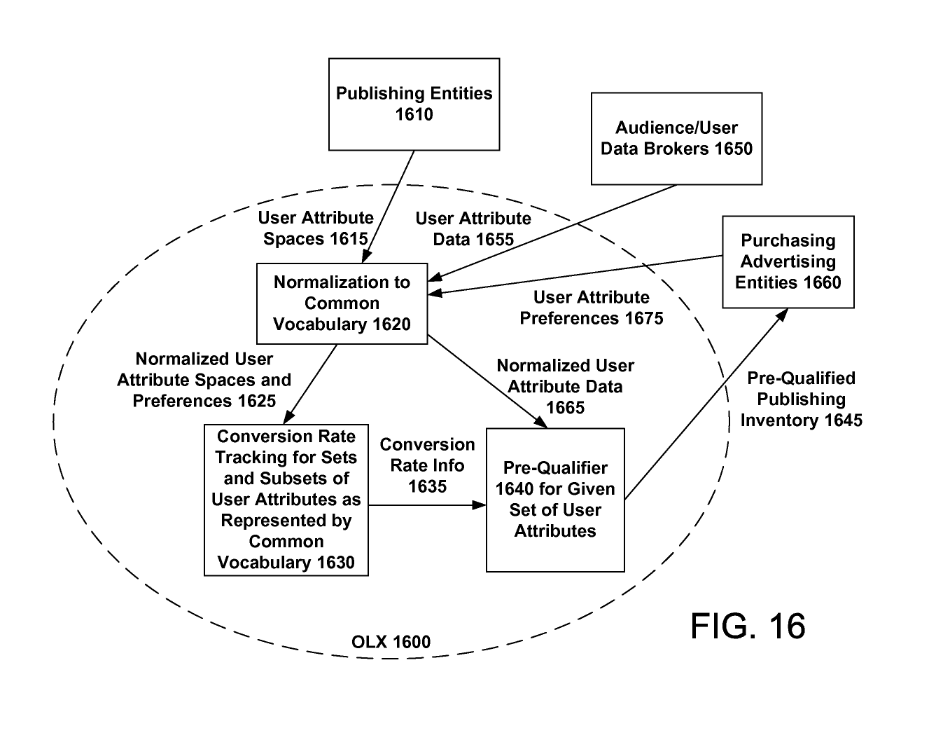

FIG. 16 represents several aspects of various embodiments of the invention. As mentioned, publishing entities 1610 present user attribute spaces 1615 and advertising entities 1660 present preferences 1675 for user attributes to normalizer 1620. Normalizer 1620 in turn normalizes the user attribute spaces 1615 and preferences 1625 to normalized user attribute spaces and preferences 1625, which are used in connection with matching buyers and sellers for transactions completed in the exchange 1600. Audience/user data brokers 1650 may collect user attribute data 1655 which can be input to the exchange 1600 and normalized by component 1620 to produce normalized user attribute data 1665. This extra information can be used in connection with completing transaction in the exchange 1600 as described above. The component 1630 tracks conversion rates for sets and subsets of user attributes represented by the normalized vocabulary for user attributes within the exchange 1600, which produces conversion rate info 1635. The conversion rate info 1635 for different sets and subsets of user attributes and the normalized user attribute data 1665 from audience data brokers 1650 can be used by a pre-qualifier 1640 that, for a given set of user attributes, generates pre-qualified publishing inventory 1645 for prospective purchase by advertising entities 1660. Since the publishing inventory 1645 is pre-qualified for a given set of user attributes according to the normalized representation of user attribute space in the exchange 1600, the advertising entities have greater certainty over transactions, for which they may be willing to pay a premium over uncertain inventory.

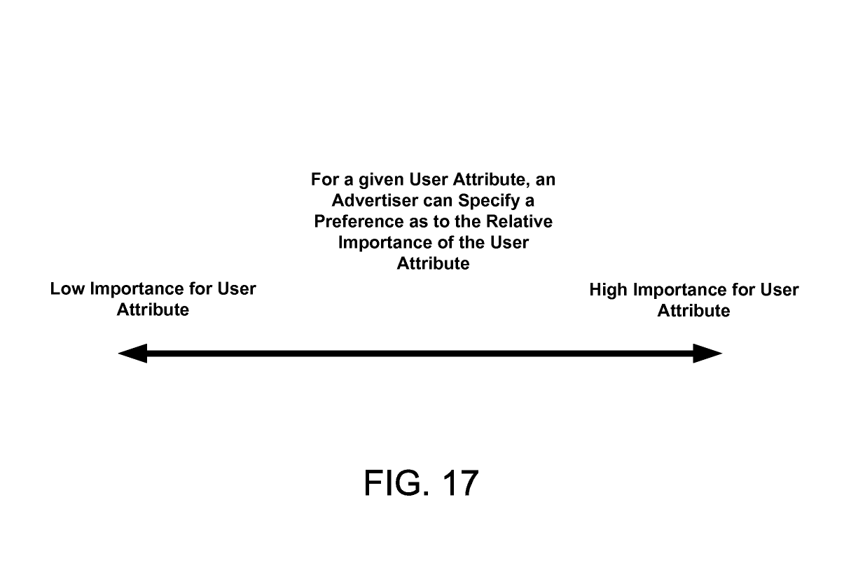

FIG. 17 shows the general concept of an advertiser expressing a preference for a user attribute along a continuum. As mentioned, in one embodiment of the invention, all preferences concerning user attributes by advertisers are normalized to a common vocabulary for comparison against normalized user attribute spaces of publishing inventory. Thus, one way to express user attributes in accordance with the invention is to express the importance of a user attribute along a continuum. A set of controls or “knobs” are thus given to each advertiser enabling control over the relevance, i.e., weight, of a given user attribute for transactions in the exchange.

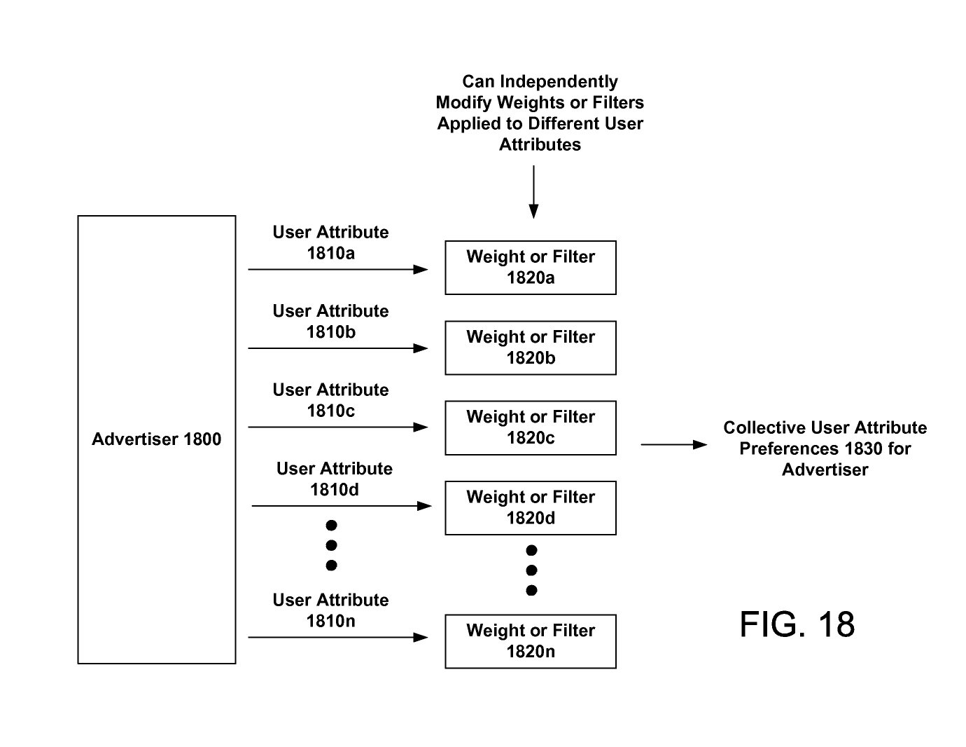

FIG. 18 is a block diagram illustrating the filtering or weighting of user attributes that may be specified by an advertising entity to an online advertising exchange in accordance with the invention. As shown, an advertising entity 1800 may express a variety of user attributes 1810a, 1810b, 1810c, 1810d, . . . , 1810n as variously described herein, however, the advertising entity 1800 may not value all of the different kinds of user attributes equally. Accordingly, an advertising entity 1800 can adjust the effects of each of the various kinds of user attributes that can be specified by the advertising entity 1800 to the exchange. Such adjustments are made by weighting, or filtering, the different user attributes with corresponding weights or filters 1820a, 1820b, 1820c, 1820d, . . . , 1820n. The weighted result is then combined into an aggregate or collective user attributes 1830 for the advertising entity. Since the weights and filters are independently adjustable, an advertising entity 1800 can fine tune their preferences for advertising transactions by making small adjustments as their preferences with respect to user attributes evolve over time. In addition, a weight of zero applied to any user attributes is a statement that the particular user attribute is of no relevance.

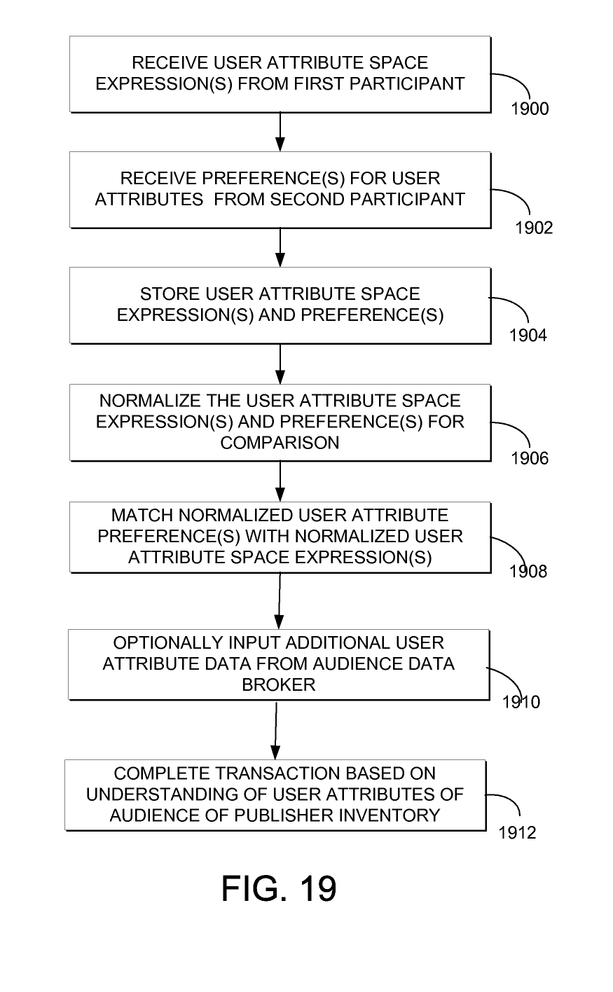

FIG. 19 is a flow diagram illustrating an exemplary process for receiving and normalizing user attribute preferences and spaces input by participants to an exchange in accordance with the invention. For instance, at 1900, a first expression of user attribute space(s) is received from a first participant in the exchange. At 1902, a second expression of preference(s) for user attributes is received from a second participant in the exchange. These user attribute space(s) and preference(s) are stored for their respective participants at 1904. At 1906, the expressions for user attribute space(s) and preference(s) are normalized for comparison within the exchange despite differing definitions outside the exchange. At 1908, the exchange operates to match normalized user attribute preference(s) with normalized user attribute space(s). Optionally, at 1910, additional user attribute data can be input to the exchange by audience data brokers as elsewhere described herein. Also, at 1912, transactions are completed by the participants in the exchange based on the understanding of user attributes enabled by the invention.

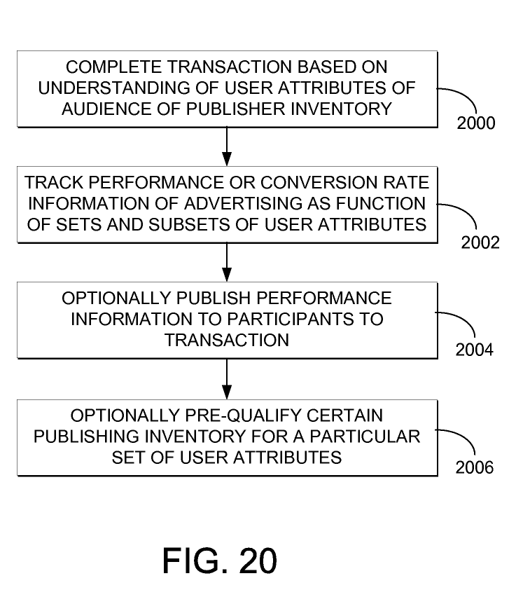

FIG. 20 is a flow diagram illustrating an exemplary process for tracking performance as a function of user attributes for transactions of an exchange in accordance with the invention. As mentioned, at 2000, based on the additional understanding of user attributes, a transaction may be completed by participants to the exchange. At 2002, the performance or conversion rate of advertising as a function of sets and subsets of user attributes is tracked in order to identify optimal user attributes as described elsewhere herein and then at 2004, the conversion rate or performance information may be published to the participants to the transaction. Also, optionally, at 2006, publishing inventory that is known to satisfy certain pre-qualification criteria with respect to a set of user attributes, either via the conversion tracking information exposed by the exchange of the invention, or via the user data provided by audience data brokers, becomes pre-qualified for that set of user attributes in the exchange. As a result, the publisher that owns the pre-qualified inventory may be able to charge a premium for exposing such information to the exchange relative to a party that is unwilling to share user attribute data and thus is unknown.

The invention may also be implemented in a peer-to-peer architecture, wherein processing performed by the various embodiments of an exchange of the invention is shared across multiple participating machines. In such a non-limiting embodiment, each machine participating in the exchange network enabled by the invention can share some of the processing associated with normalization and tracking processes performed by the various embodiments of the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to any of the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for facilitating transactions for advertisement space in an advertising exchange, comprising:
receiving a first expression of a first user attribute space from a first publishing entity in the advertising exchange according to a first standard that defines a first plurality of user attributes of an audience for publishing inventory available in the advertising exchange;
receiving a second expression of a second user attribute space from a second publishing entity in the advertising exchange according to a second standard that defines a second plurality of user attributes, different from the first plurality, of an audience for publishing inventory available in the advertising exchange;
normalizing the first expression to a standard representation for user attributes within the exchange via a first mapping function; and
normalizing the second expression to the standard representation for user attributes within the exchange via a second mapping function.

2. The method of claim 1, further comprising:
analyzing and pre-qualifying the first or second user attribute spaces for a given set or subset of user attributes represented by said standard representation for user attributes within the exchange.

3. The method of claim 1, wherein said normalizing steps include normalizing to a standard representation for user attributes within the exchange according to at least one probabilistic mapping between at least one user attribute of the first and/or second user attribute spaces and at least one user attribute of the standard representation of the user attributes.

4. The method of claim 1, further comprising:
transacting at least one transaction in the exchange by the first publishing entity or the second publishing entity based on comparing at least one preference for user attributes to the standardized representations of the first and second expressions.

5. The method of claim 4, further comprising:
receiving supplemental user attribute data by the exchange from an audience data broker, wherein said transacting includes transacting by the first publishing entity or the second publishing entity based on the supplemental user attribute data.

6. The method of claim 4, further comprising:
for a transaction of the at least one transaction, automatically tracking performance information that represents the performance of advertising or publishing inventory represented by the transaction as a function of user attributes of the audience for the advertising as published.

7. A computer readable medium comprising computer executable instructions for carrying out the method of claim 1.

8. A system to facilitate trading of advertising, comprising:
a publisher broker to represent at least one publisher, wherein the publisher broker determines at least one ask for an advertisement space of the at least one publisher;
an advertiser broker to represent at least one advertiser, wherein the advertiser broker manages at least one bid for the advertisement space by the at least one advertiser; and
an exchange to facilitate a transaction for the advertisement space between the publisher broker and the advertiser broker,
wherein disparate definitions of different user attribute spaces for different advertisement spaces received by the exchange are normalized to a common user attribute space within the exchange via a mapping function.

9. The system of claim 8, wherein the common user attribute is a subset of elements common to the different user attribute spaces.

10. The system of claim 8, whereby the exchange can translate from the common user attribute space to the different user attribute spaces for different advertisements spaces via a mapping function.

11. The system according to claim 8, wherein the exchange tracks performance information about a performance characteristic for at least one advertisement of the plurality of transactions as a function of the user attributes for the at least one advertisement when published.

12. A method for facilitating transactions for advertisement space in an advertising exchange including a publisher broker to represent at least one publisher and an advertiser broker to represent at least one advertiser, comprising:
receiving an expression of a user attribute space from a first participant in the advertising exchange according to a first standard that defines at least one user attribute of an audience for inventory available in the advertising exchange;
receiving an expression of at least one preference for a user attribute from a second participant in the advertising exchange according to a second standard that defines at least one preference for a user attribute of inventory for transactions in the advertising exchange; and
normalizing the expressions of the user attribute space and the at least one preference to a standard representation for user attributes within the exchange.

13. The method of claim 12, further comprising:
comparing the at least one preference for the user attribute to the normalized expression of the user attribute space for purposes of determining whether the inventory matches the at least one preference of the second participant.

14. The method of claim 12, further comprising:
transacting at least one transaction in the exchange by the first and second participants based on matches made by comparing the at least one preference for the user attribute to the normalized expression of the user attribute space.

15. The method of claim 14, further comprising:
for a transaction of the at least one transaction, automatically tracking performance information that represents the performance of advertising or publishing inventory represented by the transaction as a function of user attributes of the audience of the advertising as published.

16. The method of claim 15, further comprising:
for a transaction of the at least one transaction, automatically tracking the performance of advertising or publishing inventory based on the user attributes for advertising or publishing inventory represented by the transaction, while remaining blind to the identity of the first participant and second participant.

17. The method of claim 15, further comprising:
for a transaction of the at least one transaction, automatically tracking any changes to the user attributes of the advertising or publishing inventory and tracking any differences in performance of the advertising or publishing inventory as a result of the changes.

18. The method of claim 15, further comprising:
transmitting the conversion information to the first participant, to the second participant, or to both the first participant and the second participant.

19. The method of claim 12, further comprising:
transmitting the standard representation for the user attribute space to the first participant; and
transmitting the standard representation for the at least one preference for user attributes to the second participant.

20. The method of claim 19, further comprising:
translating the standard representation for the user attribute space to the first standard for the first participant; and
translating the standard representation for the user attribute space to the second standard used by the second participant.
